(19) United States
(12) Patent Application Publication
(10) Pub. No.: US 2018/0055042 A1
(43) Pub. Date: Mar. 1, 2018

(54) Portable, insulated capsules for cryopreservation of biological materials

(71) Applicant: Alberto Jose Sarmentero Ortiz, Malaga (ES)

(72) Inventor: Alberto Jose Sarmentero Ortiz, Malaga (ES)

(21) Appl. No.: 14/756,605

(22) Filed: Sep. 24, 2015

(51) Int. Cl. A01N 1/02; F25D 11/04

(52) U.S. Cl. CPC A01N 1/0257; F25D 11/04; B01L 3/50851; A01N 1/0284

(57) ABSTRACT

This invention consists in portable cryostat capsules built in several materials, dimensions and configurations according to the size of the biological refrigeratable samples to be cryopreserved and its cold storage requirements of these biological materials including umbilical cord blood, cells, semen, oocytes, tissues and bigger biological units such as organs for transplantation, entire animals or plants, including human organs or entire bodies in the cryo-medical practice. These capsules are all built in a form of thermoplastic cryostat with a cold source that is in contact with a myogenic tank, a cryo-liquid generator, a cryo-coolant unit and/or an hybrid unit (combination of an external cryogen supply in continuous flow with a closed cycle unit) and includes an outer casing and an inner vessel covered by a thermal insulating material consisting of vacuum, perlite or similar thermal insulator to inhibit the transfer of heat for the correct vitrification of the biological materials.

### RELATED APPLICATION

This application claims one or more inventions which were mentioned by same applicant in the provisional application U.S. Provisional Application No. 62/071,390, filed Sep. 23, 2014, and is now described in detail in this U.S. definitive patent application hereby incorporated.

### FIELD OF THE INVENTION

The invention pertains to the field of apparatus used to maintain constant very low temperature. More particularly, the invention pertains to refrigeration and storage apparatus for cryopreservation of biological materials.

### BACKGROUND OF THE INVENTION

Some biological applications, especially those involving very low temperature for the cryopreservation of biological materials, require a supply of cryogens such as liquid Nitrogen, (LN2) to operate. Until this patent is hereby introduced there is not in the market any cryostat capsule that can fit the both needs: the computerized cooling of biological samples in field conditions and the further long term storage in the same capsule.

The invention is a cryostat, to be built in different sizes according to the size of the biological sample or material to be cryopreserved and also to be built with different alternative features according to the degree of the automation of the equipment, the servicing options and the necessities of the clients. This invention incorporates a number of additional features designed for the friendly and smooth application for each alternative.

### BRIEF DESCRIPTION OF THE DRAWINGS

The Figures show several schematic views of the cryostats of this invention.

FIG. 1 refers to the model A capsule (standard human size) materials and weights in the basic open cycle cryostat version and illustrates the geometry of the human size individual capsule cryostat of this invention.

FIG. 2 is a view in longitudinal of the Ion-Dewar capsule, showing a longitudinal cross-section of the cryo-capsule of FIG. 1.

FIG. 3 is a view in transverse of the Ion-Dewar capsule, showing a transverse cross-section of the cryo-capsule of FIG. 1.

FIG. 4 is an enlarged detailed view of a circled area indicated as X, on FIG. 3.

FIG. 5 illustrates the geometry without limitation (which will vary depending on the size of biological materials to suit their local storage), their characteristics and the various embodiments of the internal box of this Ion Dewar capsule of the invention.

FIG. 6 is a cross-sectional view along the line A-B on FIG. 5.

FIG. 7 is a cross-sectional view along the line C-D on FIG. 5.

FIG. 8 illustrates the geometry without limitation (which will vary depending on the size of biological materials to suit their local storage), the door of this Ion Dewar capsule of the invention.

FIG. 9 is a cross-sectional view along the line E-F on FIG. 8.

FIG. 10 is an enlarged detailed view of a circled area indicated as Y, on FIG. 9.

FIG. 11 illustrates the geometry without limitation willvary (which depending on the size of biological materials to suit their local storage), their characteristics and the various embodiments of the external box and reinforcements this Ion Dewar capsule of the invention.

FIG. 12 is a cross-sectional view along the line A-B on FIG. 11.

FIG. 13 is a cross-sectional view along the line C-D on FIG. 11.

FIG. 14 illustrates a longitudinal perspective view of a human-size thermoplastic capsule of this patent. i.e: Polyurethane-perlite cryostat.

FIG. 15 illustrates a transverse perspective view of the human-size thermoplastic capsule of this patent.

FIG. 16 illustrates a perspective view of the human-size thermoplastic capsule of this patent.

FIG. 17 is a top view illustrating a cross-section of the human-size thermoplastic capsule of FIG. 16.

FIG. 18 illustrates a transverse cross-sectional view of the human-size thermoplastic capsule of FIG. 16.

FIG. 19 illustrates a longitudinal cross-sectional view of the human-size thermoplastic capsule of FIG. 16.

FIG. 20 illustrates the smallest-sized cryostat models of this patent. Image files refer to the model D capsule (umbilical cord blood & other cells or small samples of tissues) materials and weights in the basic open cycle cryostat version. Other figures of these models as recited in the above text and tables have been done but intentionally omitted in this list of figures, as they are already well described.

FIG. 21 is a fragmented view illustrating the components of the cylindric model of the small capsule of this patent, 3D Images and sections.

FIG. 22 is a top cross-sectional view of the capsule of FIG. 21 illustrating the flexible polyurethane ring.

FIG. 23 is an enlarged detailed view of a circled area indicated as Z, on FIG. 22.

FIG. 24 is a perspective view of the capsule of FIG. 21.

FIG. 25 is a side cross-sectional view of the capsule of FIG. 21, without an insert or a lid.

FIG. 26 is a side cross-sectional view of the capsule of FIG. 21.

FIG. 27 is an exploded view of the capsule of FIG. 21 illustrating the metal (Stainless Steel) components of the inner part of small cylinder cryostat of this patent.

FIG. 28 is a lay out sketch illustrating a hybrid Ion Dewar capsule system of the invention.

FIG. 29 is a lay out sketch illustrating a hybrid Ion Dewar capsule system of the invention.

FIG. 30 is a perspective view of an unipersonal ion dewar capsule with wheel set for pre-cooling and shipping.

FIG. 31 illustrates a thermoplastic medium sized cryostat of this patent, first designed for medium sized animals but also able to cryopreserve some humans in fetal position.

FIG. 32 is a top view illustrating a cross-section of the thermoplastic medium sized cryostat of FIG. 31 and possible dimensions of the medium size thermoplastic capsule of this patent.

FIG. 33 illustrates a transverse cross-sectional view of the human-size thermoplastic capsule of FIG. 31.

FIG. 34 illustrates a longitudinal cross-sectional view of the human-size thermoplastic capsule of FIG. 31.

FIG. 35 is a perspective view of a medium sized basic model B-type capsule of this patent.

FIG. 36 is a view in longitudinal of the medium sized basic model B-type capsule, showing a longitudinal cross-section of the capsule of FIG. 35.

FIG. 37 is a view in transverse of the medium sized basic model B-type capsule, showing a transverse cross-section of the capsule of FIG. 35.

FIG. 38 is an enlarged detailed view of a circled area indicated as V, on FIG. 37.

FIG. 39 is a perspective view of an organ-sized basic model of C-type capsule of this patent.

FIG. 40 is a view in longitudinal of the organ-sized basic model of C-type capsule, showing a longitudinal cross-section of the capsule of FIG. 40.

FIG. 41 is a view in transverse of the organ-sized basic model of C-type capsule, showing a transverse cross-section of the capsule of FIG. 40.

FIG. 42 is an enlarged detailed view of a circled area indicated as W, on FIG. 43.

### BRIEF DESCRIPTION OF THE INVENTION

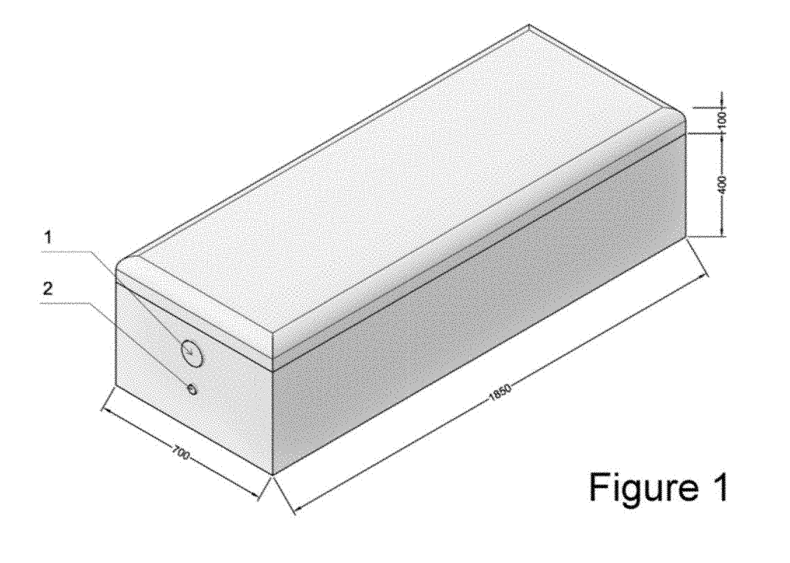

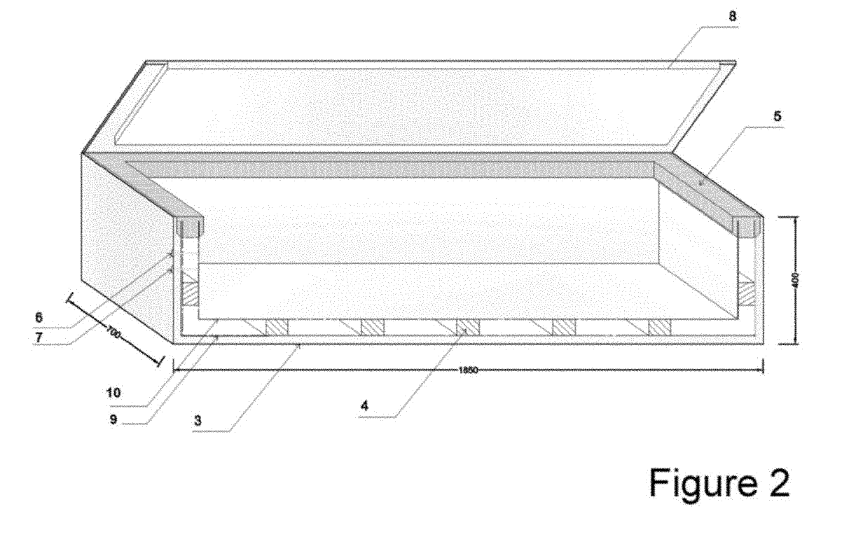

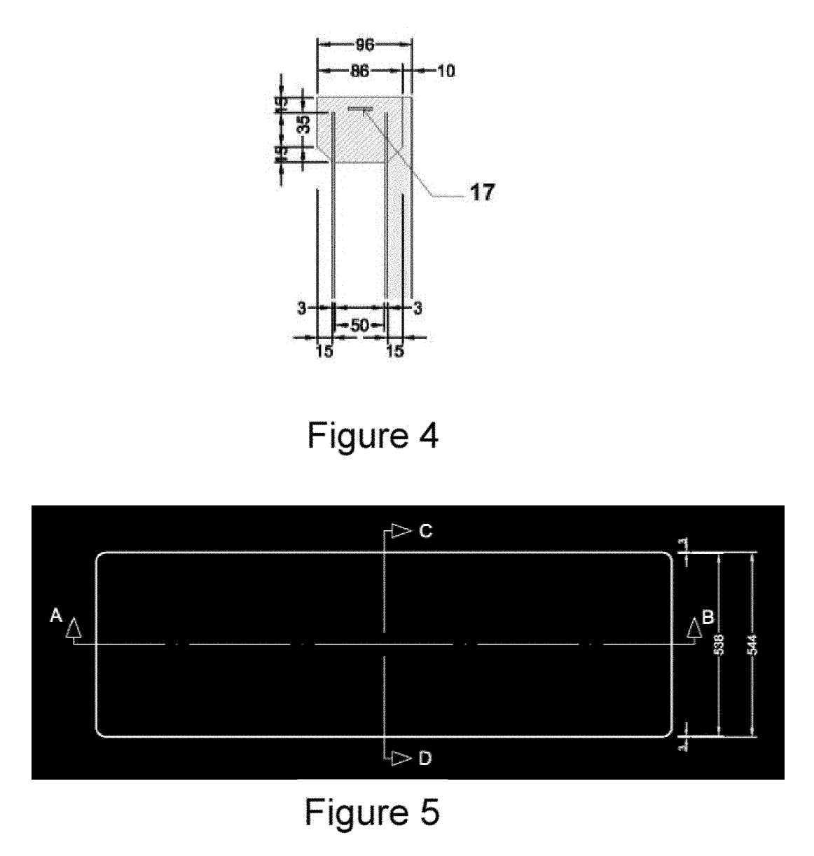

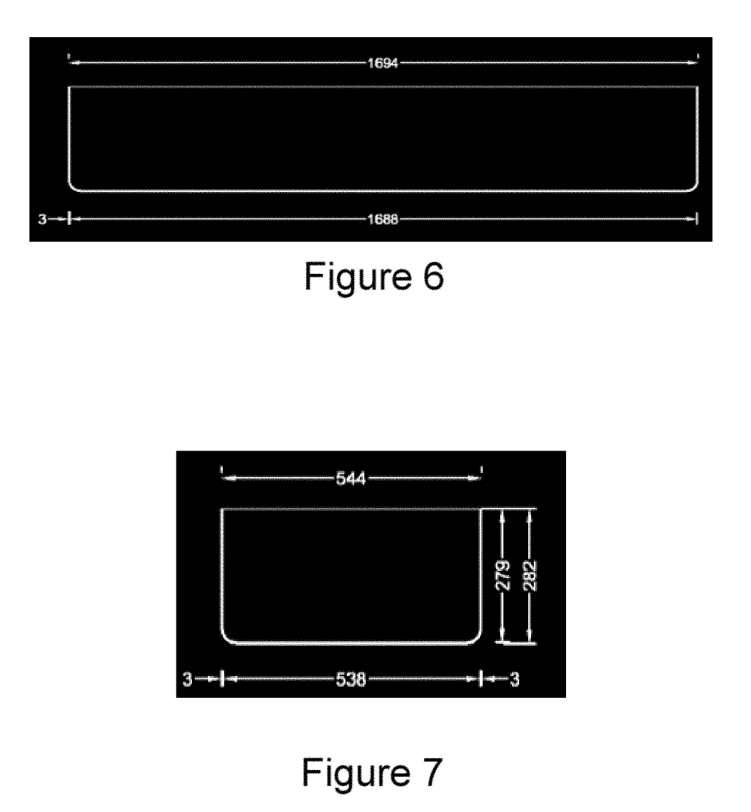

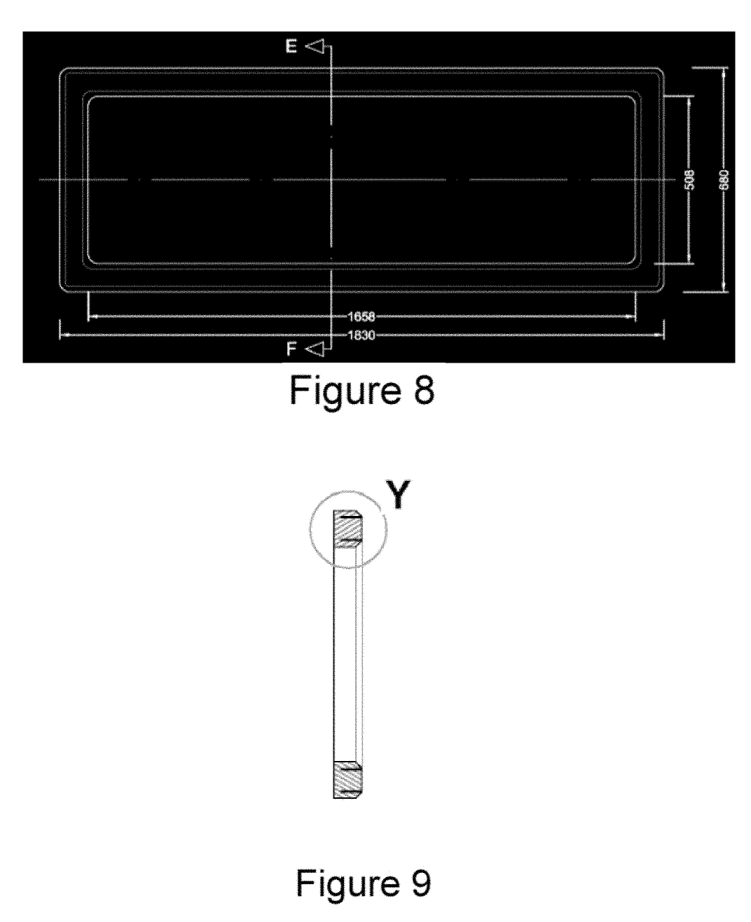

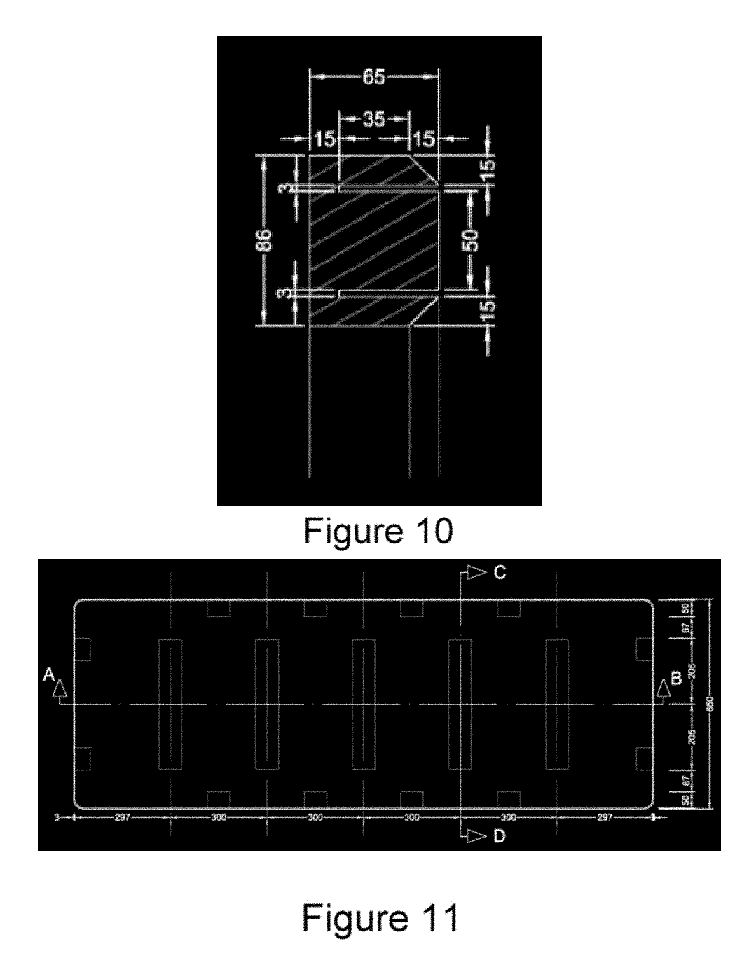

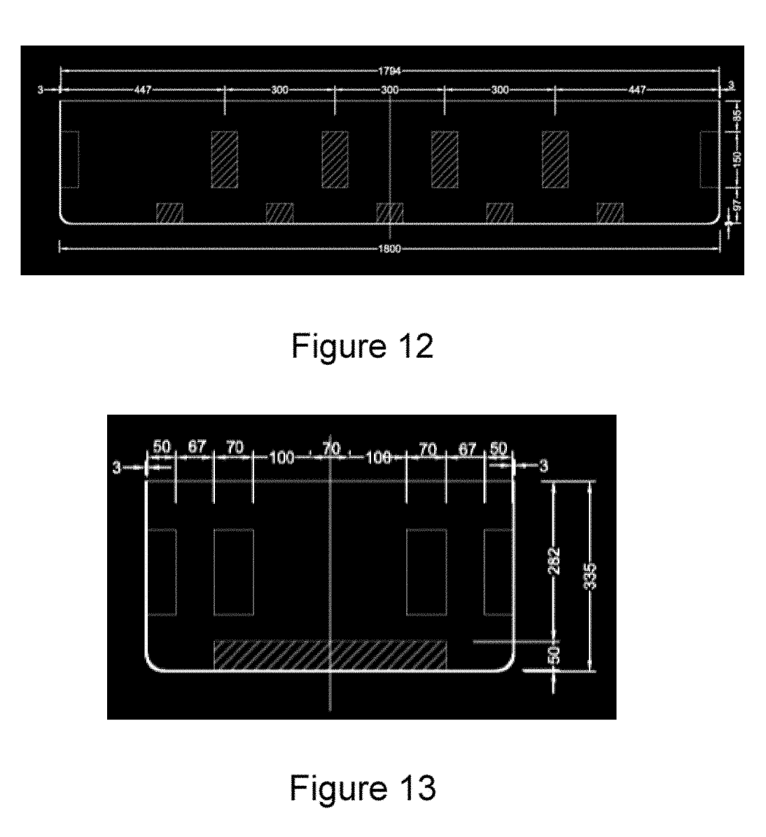

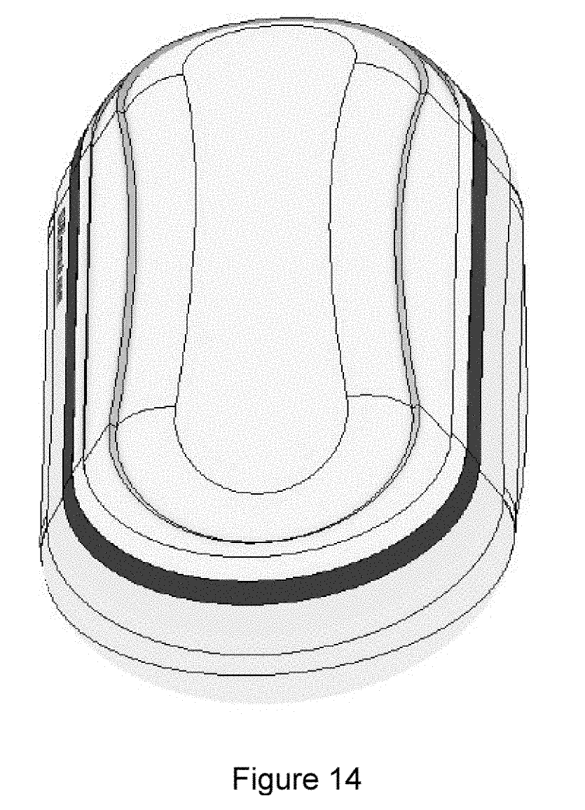

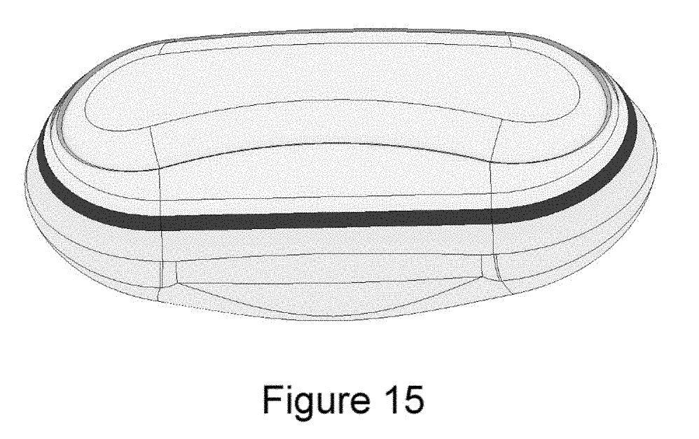

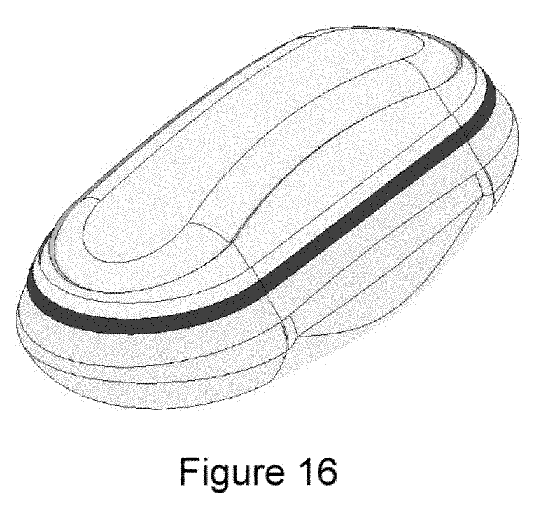

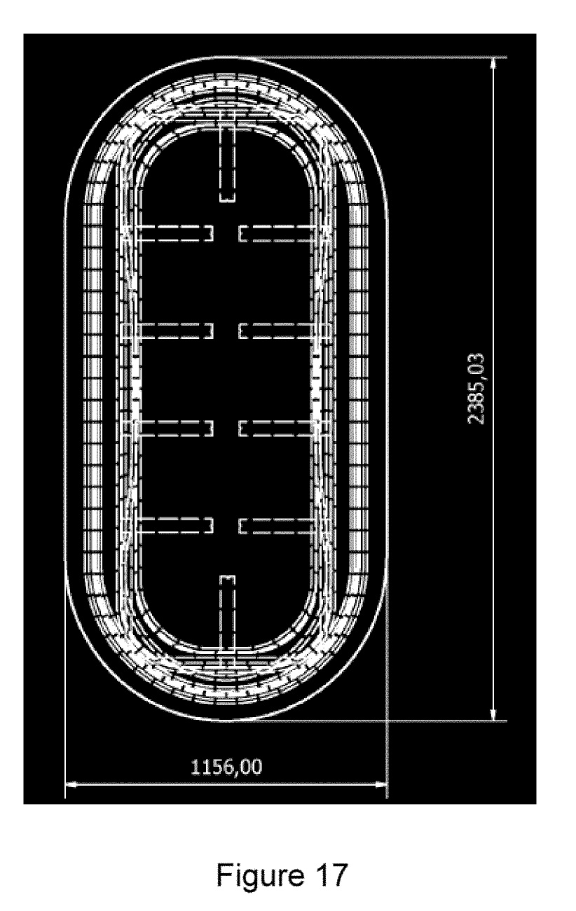

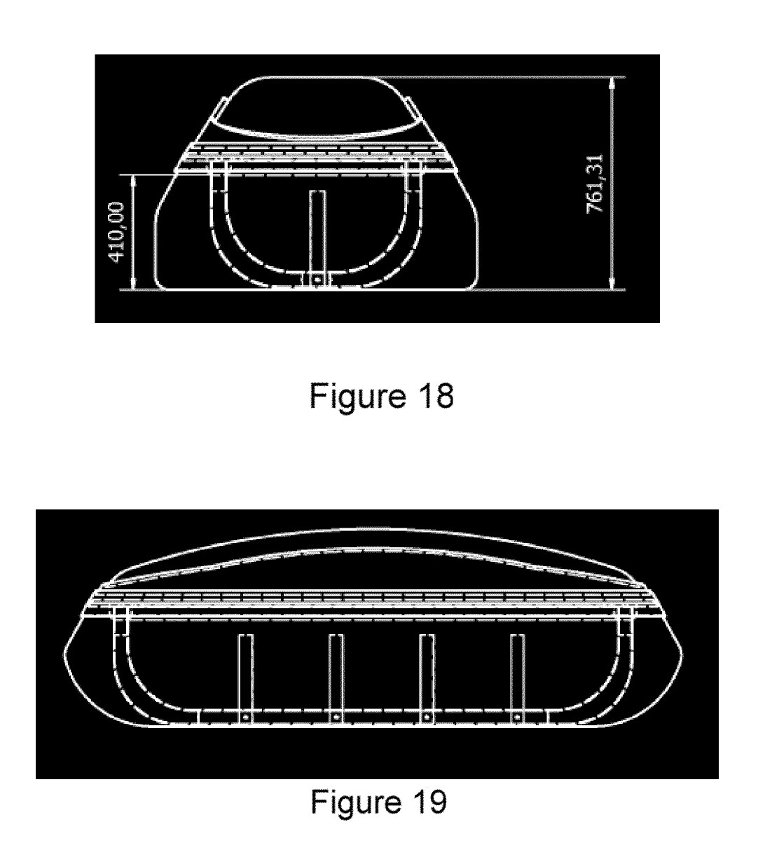

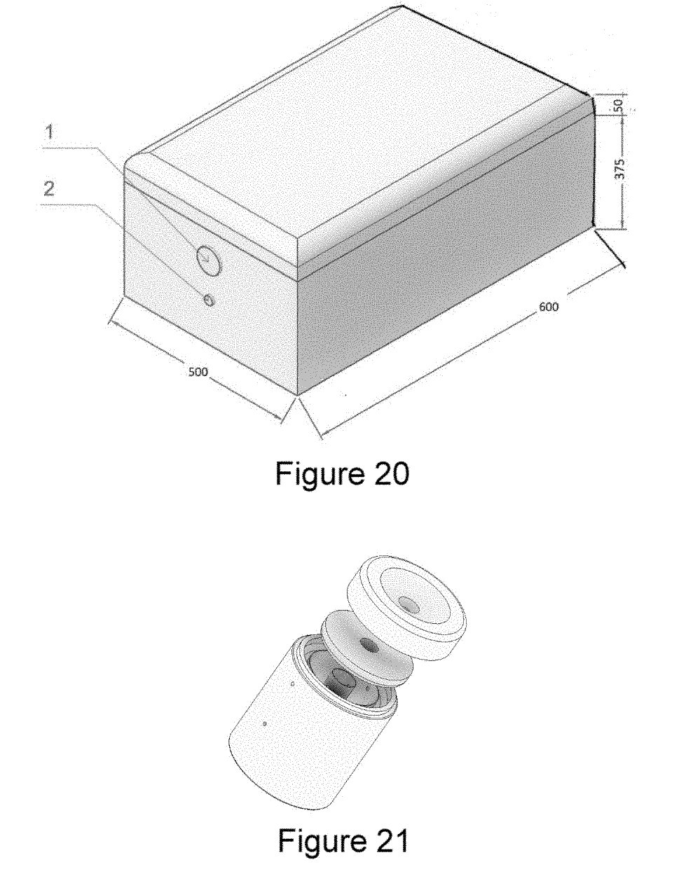

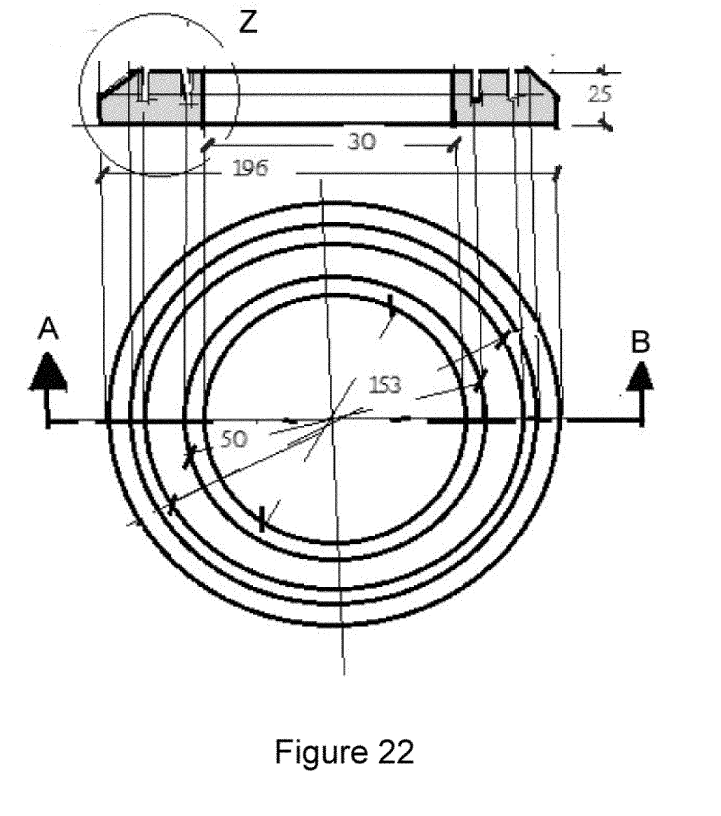

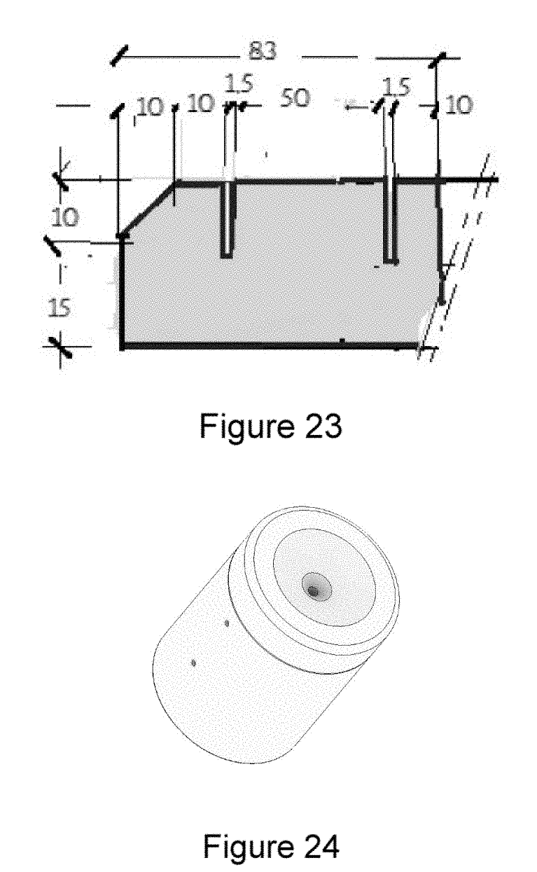

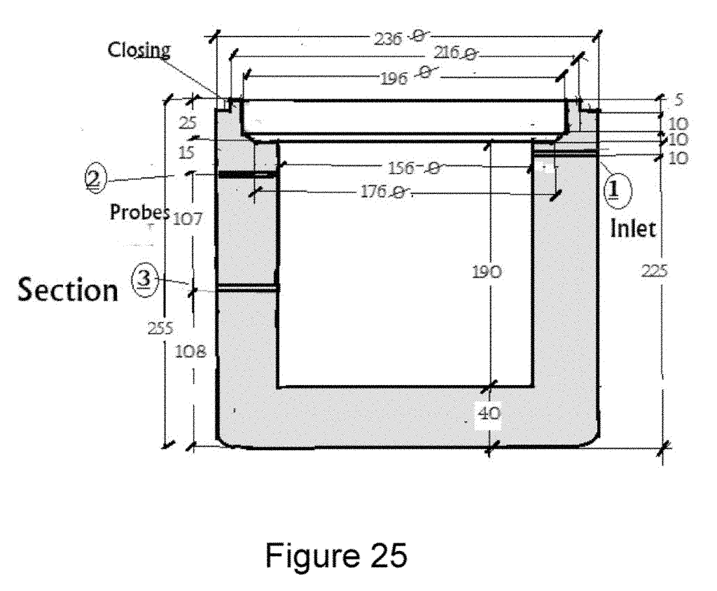

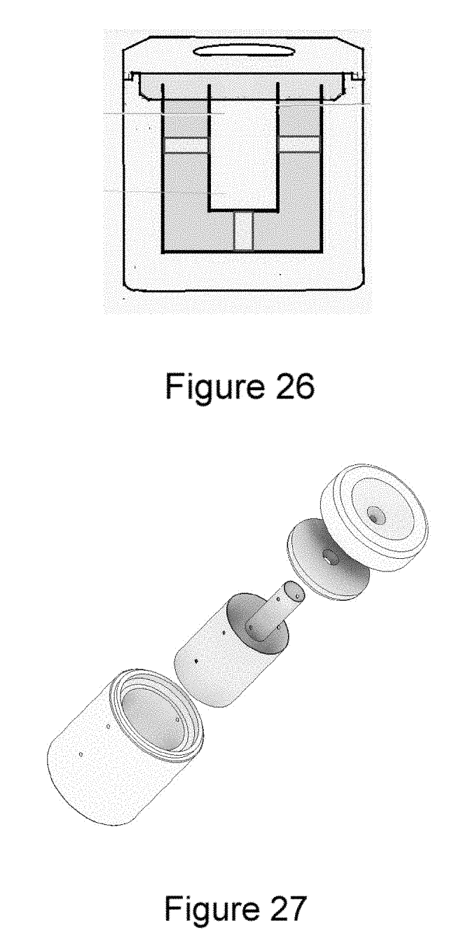

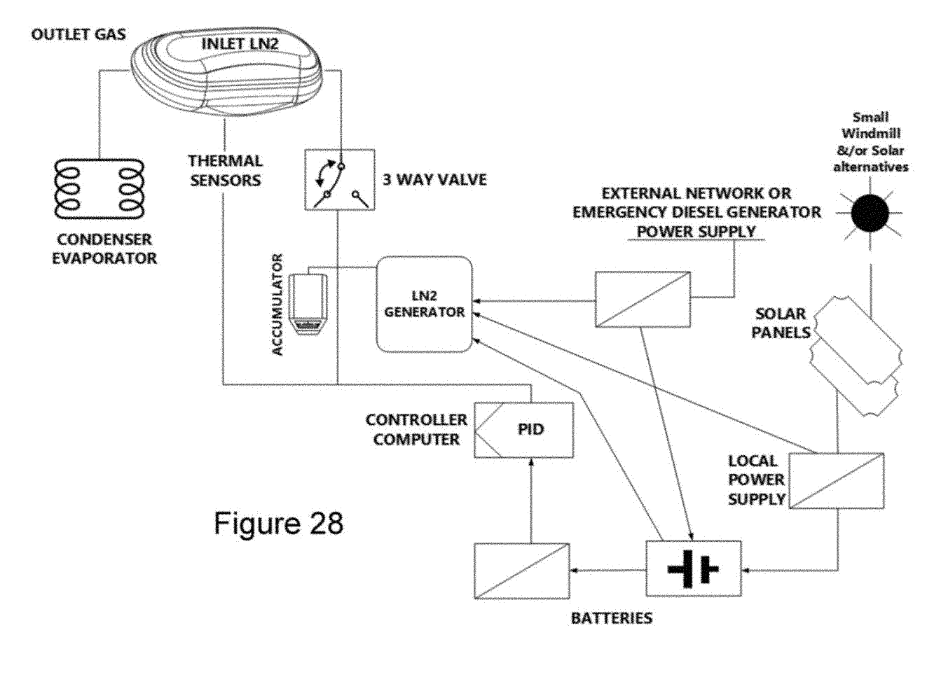

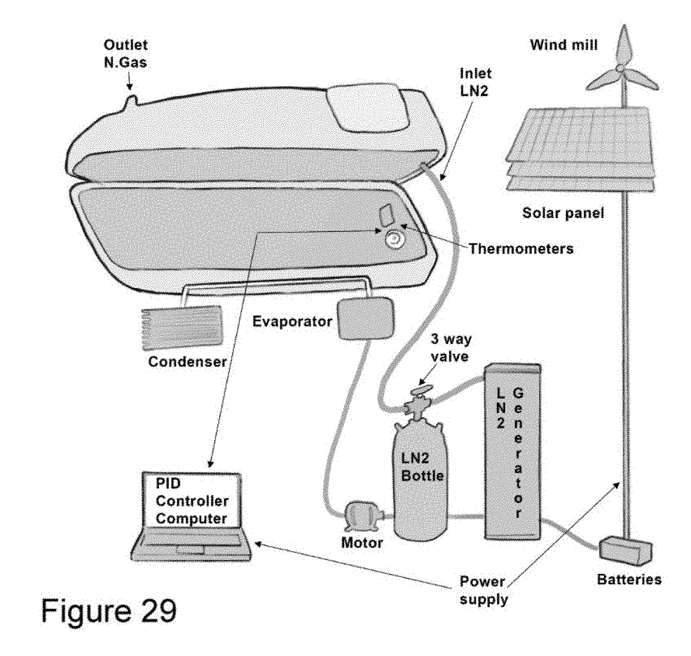

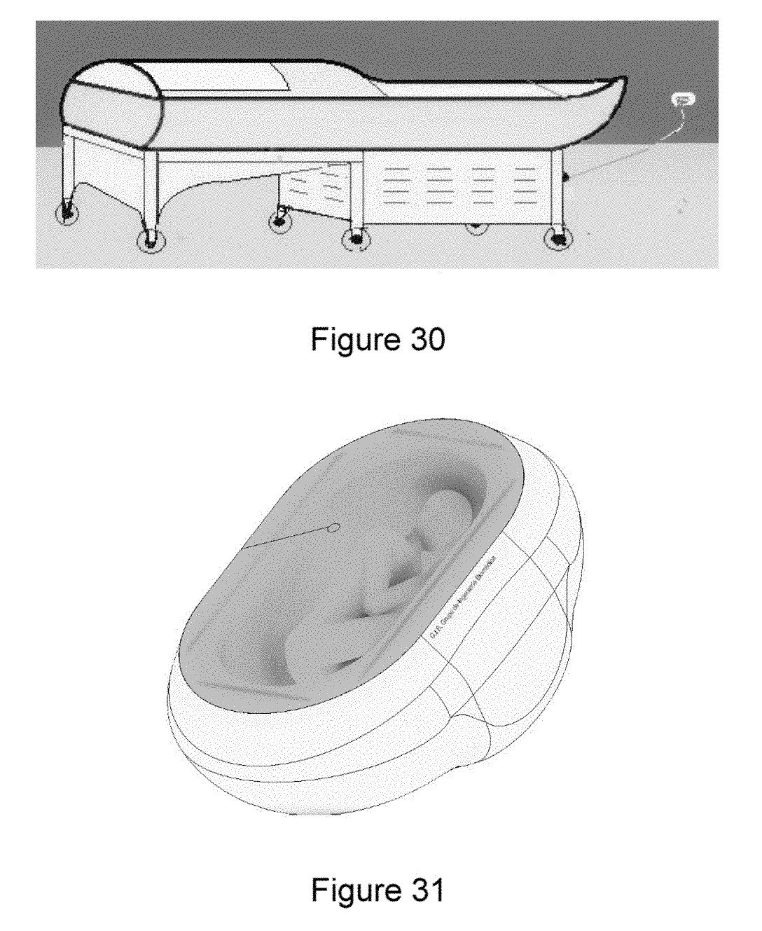

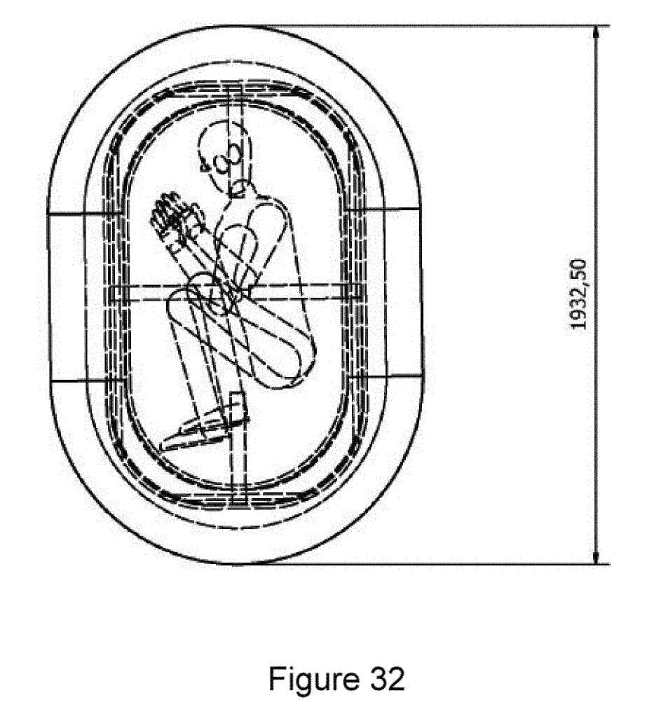

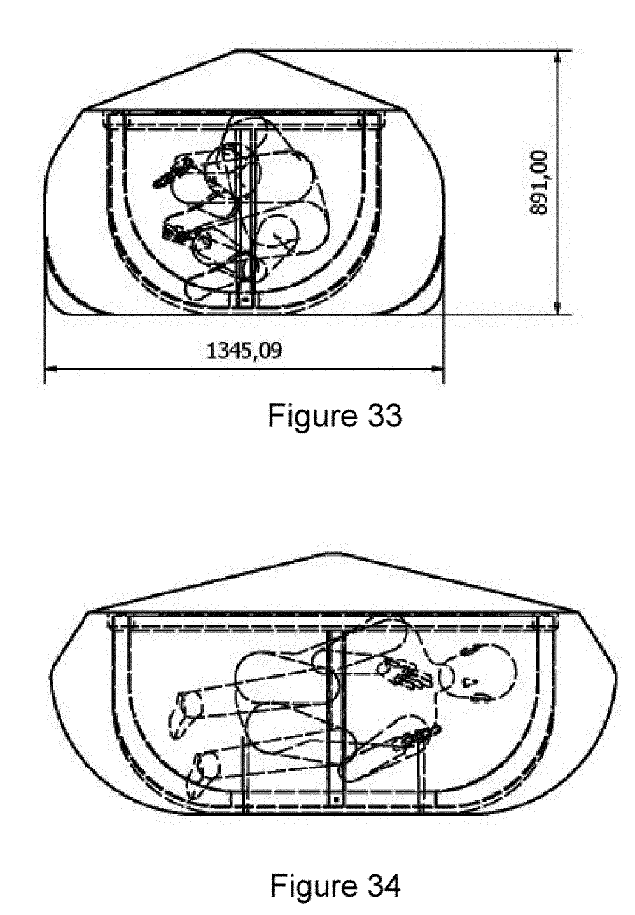

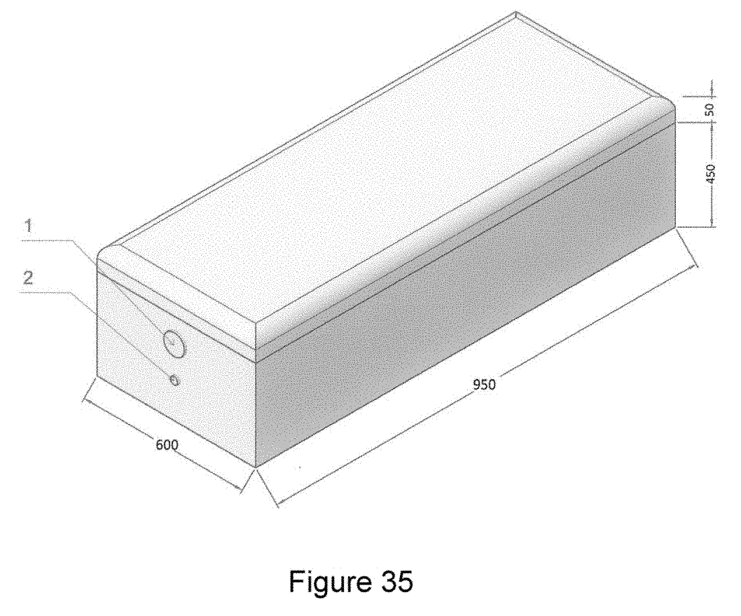

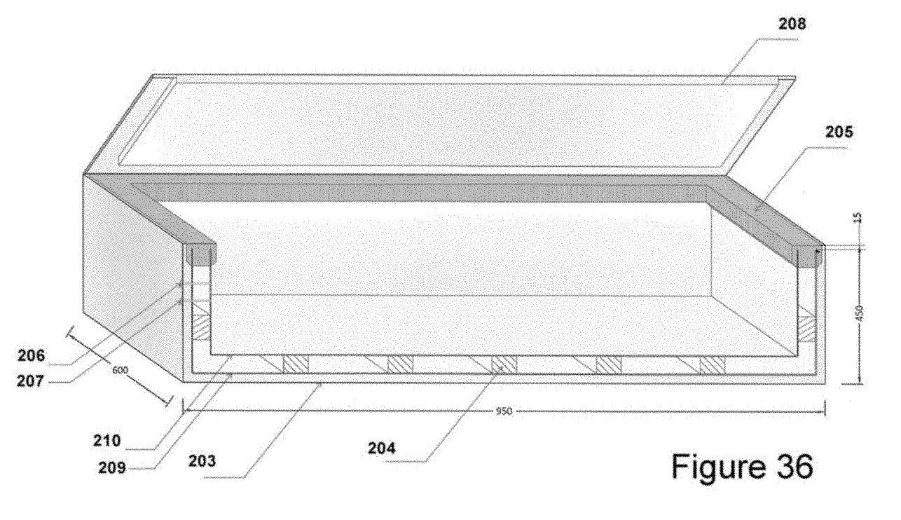

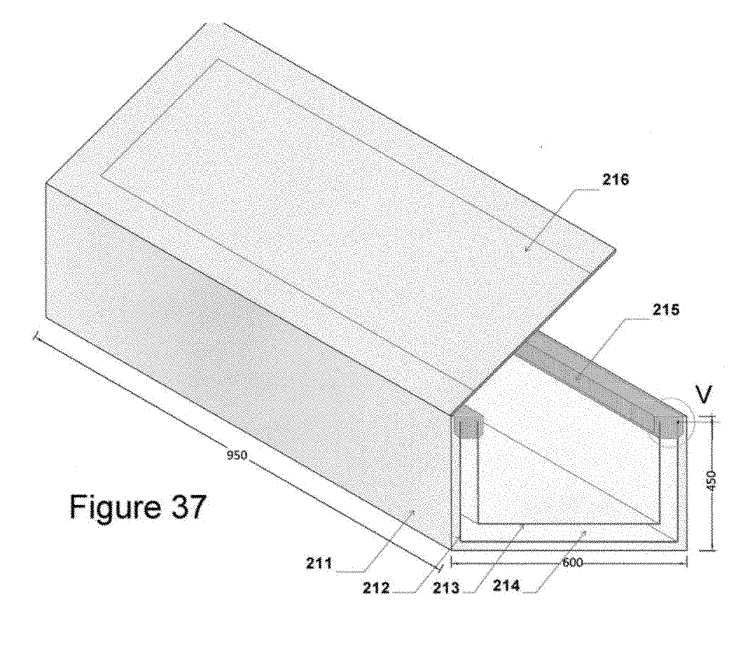

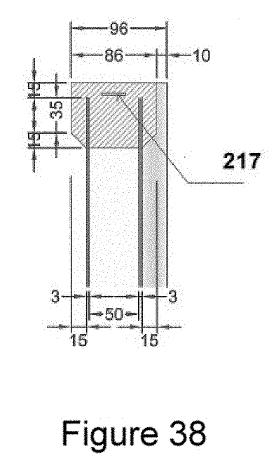

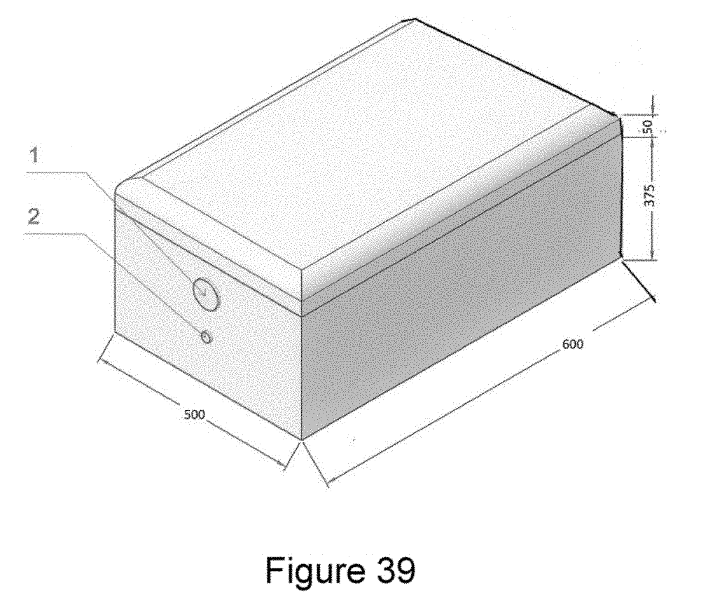

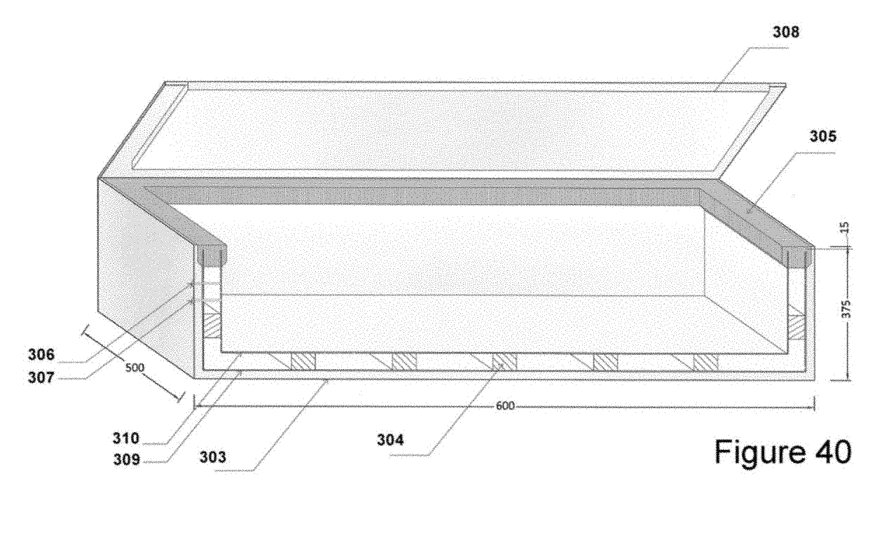

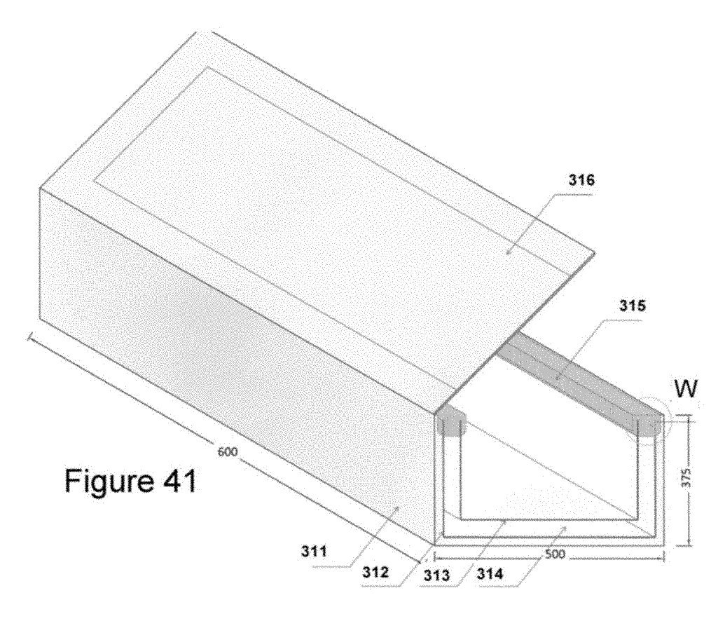

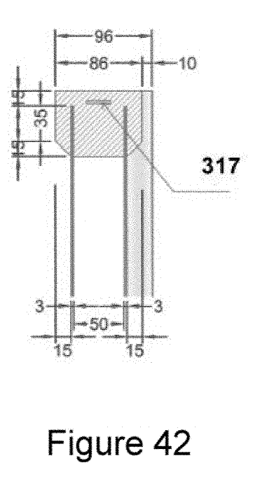

FIGS. 1 to 4 shows several illustrations of the cryostats of the invention, along with a panoply of complementing devices, objects, assemblages, lay outs, procedures and instruments of this invention. In FIG. 1, “1” is the connector to the electrovalve for LN2 and “2” is the digital thermometer.

The cryostat has a chamber for containing the low-temperature liquid LN2 or other cryogen surrounding the inner vessel containing the biological sample. The lower part is surrounded by a radiation shielding which limits absorption of heat from the surroundings to the cryogen. The top of the cryostat is capped with a flange.

The invention includes de possibility of incorporating a cryo-cooler to be used to produce the low-temperature required for cooling the device.

Optional Cryogen LN2 from a storage tank is fed through a pressure regulator and hose into the neck of the cryostat. In the case of the Ion Dewar hybrid type cryostat alternative of this invention, the liquid cryogen drips from the condenser, and collects in a pool of liquid in the cryostat. Additionally, any cryogen which boils off from the pool due to heat from the device rises up, and can be re-condensed by contact with the condenser minimizing loss of cryogen or maintain low or zero boil-off.

In order to further minimize heat transfer to the liquid cryogen, there is a radiation shield installed in the external part of the capsules.

It will be understood by any one skilled in this art that while the various figures have shown the cryostat of the invention, this invention is not limited to any particular type of cryostat. Open cycle continuous-flow cryostats could be used, hybrid types or closed cycle of other kinds, within the teachings of the invention.

Accordingly it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

While the human knowledge of the technologies of “heat” is very old—since many thousands of years ago in the early Paleolithic times when production of fire was discovered—the so called “technologies of cold” are relatively new (as late as XIX century). Therefore the most significant advancements in this field are very recent and obviously it has a lot of room for many significant discoveries and improvements to be made, along with scientific and technological challenges to face from the initial cooling of biological samples in field conditions to the stable storage of biological materials for extended periods of time. This late requires very cold temperatures. The crystal glass transition temperature is between −80° C. and −130° C. Below this temperature molecular motion is minimized and the chemical reactions and storage for indefinite periods of time becomes possible.

The capsules of this patent described herein are aimed to covering several gaps, one of them: as the only existing appliance or equipment for biological, medical or veterinary practice designed to meet both needs of controlled cryo-cooling of biological materials in field conditions and their individual long-term cryo-preserving storage in the same apparatus. The devices of this patent are then suitable to work well with the several methods currently used for the successful cryopreservation of most biological materials including whole organs, organ sections, tissues and cells or entire bodies of animals in a non-frozen (vitreous) state, comprising cooling the biological material to be preserved in the presence of a non-toxic vitrifying protective solution to at least the glass transition temperature thereof to vitrify the solution without substantial nucleation or ice crystal growth and without significant injury to the biomaterial.

Among these suitable methods for the cryo-preservation of the several types of biological cells, the ultra-fast cooling/warming system is used in the cryostats of this invention to achieve vitrification of individual cells or cell suspensions with a low concentration of cryo-protectant agents to attenuate the formation of intracellular ice crystal formation during cooling, and to minimize or avoid any de-vitrification impact during subsequent warming.

The low temperature within the ion-Dewar of this patent can he maintained indefinitely by liquid nitrogen (LN2) supply which is the most common and inexpensive cryogen, but it may also be used other cryogens like dry ice (solid carbon dioxide, which works well for cargo shipping hermetic capsules), liquid helium, or liquid hydrogen among others.

The materials used in the several types of cryostats of this patent, have been proven suitable in former experiences include stainless Steel, oxygen-free Copper, Aluminum, duralumin, alloys and polymers of low thermal conductivity and low specific deformation at low temperatures including Teflon, Tufnol, Garolite, Polyurethane and. Epoxy, which is used along with welding for thermal bonds. Such materials in addition have a good thermal behavior and are mechanically strong since they are subjected to great stress due to variations in its coefficient of expansion when freezing or subsequent heating.

It is also very important to minimize the effects of radiation with shaped external covering with radiant shielding of aluminum metalized foil and/or other equivalent radiation-reflective materials to inhibit heat transfer by thermal radiation and effectively reflect the maximum possible degree of radiation while keeping the biological materials well isolated as well as to reduce the pressure on the surface of the cryogenic liquid and thereby lower its temperature.

The capsule device systems of this patent may further be suitable for applying oscillating heat pipe (OHP) and nano-fluid techniques to be built through micro-fabrication. Several capsules of this patent may also be networked to increase the total volume of samples that the cryopreservation system can process simultaneously.

### DETAILED DESCRIPTION OF THE INVENTION

This invention relates to an apparatus—built in diverse sizes and several shapes for cryopreservation and long-term cold storage of biological tissues and/or any other biological refrigeratable materials such as umbilical cord blood, cells, semen, oocytes, stem cells and bigger biological units such as plants, organs, portions of organs, or entire animals (especially those of endangered species) for further use in the veterinary practice, and it can be used also for long term cold storage of human organs or entire bodies in the cryo-medical practice.

The invention is a cryostat capsule built in different configurations, dimensions and related equipment according to the size of the biological sample or material to be cryo-preserved and also according to the different features and the degree of automation required as well as the servicing options, all that respectively depending on the necessities of the final users. This invention incorporates a number of alternative methods, components, complements and features designed for a friendly and smooth application of each bio-cryopreservation task.

In spite of the different dimensions of the said capsules (herein named Ion Dewar) they are all built in a form of cryostat with a cold source that is in contact with a cryogenic tank, a cryo-liquid generator, a cryo-coolant unit and/or an hybrid unit (combination of an external cryogen supply in continuous flow with a closed cycle unit) and includes an outer casing and an inner vessel covered by a thermal insulating material consisting of vacuum, perlite or similar thermal insulator to inhibit the transfer of heat therethrough, and it is also protected by radiation shielding to maintain the lower temperatures provided by the cryogenic source.

The smallest sized cryostat of this patent could be considered an appliance for the cryopreservation of small biological materials like the said stem cells, umbilical cord blood, umbilical tissue, as well as other cells or biological tissues using thermoplastic heat-sealed micro-capillar polymer straws resistant to deformation when placed in the sample holder and introduced in liquid nitrogen for correct vitrification while preventing cross contamination.

In order to build the different configurations of the capsules of this patent, modular bases are used herein with either one of the three main types of cryostats: open or closed cycle or hybrid type, using the same kind of container depending on the necessities and sometimes also the budget) of the final user.

Most characteristics and features of the designs of this invention were conducted in a standardized fashion to satisfy both the easiest possible maintenance requirements, spare parts availability and the needs of long duration and lightweight construction for easy transport There are several configurations and automation alternatives to choose from within this invention.

The more simple units allow the largest section to accommodate a greater volume of cryogen liquid normally required.

These and other advantages of the invention set forth in this description are given for illustrative but no-limiting purposes.

In the case of the open cycle continuous-flow cryostat of this patent, the cryogen used is liquid nitrogen (LN2) with boiling point at 77° K at atmospheric pressure, in which the sample—once prepared with cryo-protectants—is introduced and isolated in an inner vessel (in a small sample holding cylinder or a simple cryo-bag for small to medium sized samples or the below described cryo-dress) which in turn will be immersed in the cryogenic liquid (LN2) with the advantage of immediate high cooling power, inexpensiveness and no vibrations or noise. The said sample holder unit is placed in the inner part of the capsule covered by a bait-in isolating section of vacuum or perlite, externally coated with at least one layer of thermal insulation and protected with radiation shielding.

This basic cryostat is cooled by circulating LN2 in continuous flow within the inner vessel containing the sample holder, so that the main cooling is produced by conduction effect, while temperature can be adjusted by regulating the flow rate of fluids and additionally by a small resistor used as a heater to be computer activated when required in the sequential cooling process by the controlling mechanism of this patent device that includes—as an option—the control loop feedback PID (proportional-integral-derivative controller) of the whole system.

The cryostat set is surrounded by a frame-container made of rigid polyurethane, provided with refrigeration door gaskets to produce a magnetic snap ring closure forming a leak-proof seal of the cryostat including closure and strap when shipping purposes are required, and in the case of open-cycle continuous flow cryostat, once in the location for long term storage the movable cap that allows the free outlet of N2 gas outside is provided and adjusted. The inner part of the capsule has a connector for the hose to fill LN9 with an electro-valve and also a probe with a cryo-thermometer or other thermic sensor able to measure temperatures in a wide range of negative centigrade units reaching down to −196° C.

The capsules of this patent can be manufactured in at least four sizes and include four alternatives of models of cryostat for each size described below with substantial differences in costs, but all of them consisting of an outer container with certain similarities to a horizontally lying freezer but internally coated of solid polyurethane (or other cryo-resistant materials) to host the inner vessel with the sealed leak-proof sample holder. In the case of large biological samples—like entire bodies of humans—the insulating protection to avoid direct contact with the cryogen consists of a special hermetic dress suit of this invention (leak-proof custom fabrics, that could include Polyurethane or. Teflon plates covering the whole body including hands and feet). These suits could be previously tailor-made to covering the entire body including a cryo-proof helmet to cover the head hermetically fit along with the rest of the cryo-dress.

The said alternatives for each size range from the above mentioned most simple and inexpensive LN2 open cycle cryostat appliance (where LN2 is provided by an adjoining Dewar tank or set of interconnected standard cylinders from delivery supply of LN2) to the one with its own generator of LN2, or the hybrid types which combines the advantages of the electric powered cooling with the reliability of LN2. Such hybrid models of this patent may include—as an option—the facility to capture and recover most of the expelled boil-off N2 gas (and/or combination of cryo-gasses) as it escapes from the cryostat. Then it is condensed and sent back into a discharge outlet deposit of this circuit to hold the cryogenic fluid.

This capability provides the convenient possibility of using this alternative of Ion Dewar Hybrid cryostat of this patent along a period of more than one year before any LN2 is needed to be added, but at the same time it keeps the cryostat cold enough in the eventual case of a power failure lasting a determined period of security-time without any electric power supply nor LN2 extra supply. Of course this time is very much longer when additional automated external supply of LN2 from a contiguous Dewar cylinder is activated by an electro-valve powered by a UPS (Un-interruptible Power Supply) with ad hoc batteries (Ion-Lithium, including Tesla Powerwall or standard batteries previously charged with a battery charger) when the probe thermometer detects such situation. There is no interruption of cooling while the LN2 lost during power outages can be replenished at any time, though the system that could optionally be equipped with a panoply of alternative power supply resources including a diesel emergency generator or the above mentioned UPS power system, so that, in case of failing the supply of external power, it ensures a minimum of 2 weeks of full autonomous operation of the entire system at low voltage (eg: 12 volts), while sending online an alarm signal to the database.

This type of cryostat of the patent must be plugged into the electrical power supply throughout the duration of the initial cooling process of the sample or body (according to the specific procedures for their respective required cooling rates in time units). For the right (computerized or manual) cooling regulation initial process it includes a little resistor to be used as a “heater-brake” (which slows down the cooling when it's too fast in time before its final use asking term storage). It also includes a controller mechanism that could range from a simple temperature one (on/off) to a more sophisticated feedback PID (proportional integrated derivative) controller mechanism in the more complex models.

When specific critical temperature is reached, the cryostat can be set at the definitive temperature range recommended: from −130° C. to —196° C. for long term storage of the sample by using only the LN2 with or without power supply. When the vessel is attached to a closed-c cryo-freezer unit, emergency freezing is released when there is no external LN2 supply if the previously set ideal cryogenic temperature eventually drops in the Ion-Dewar thermometers. In the open cycle cryostats, the introduction of liquid nitrogen LN2 to be held at the cryopreservation vessel can be done by either one of the following alternatives:
a) As a first and less expensive alternative it consists of one or two LN2 standard Dewar cylinder tanks feeding a storage unit of cryogenic LN2, protected by a covering case section, isolated by vacuum and also protected from radiation by shielding for prolonging the time of evaporation of said liquid, and a dose dispenser device to regularly feed the open cycle cryostat, according to the LN2 feed requirements. This dose dispenser will be set automated to open the electro-valve according to the digital thermometer indications: When the temperature rises to a predetermined level, a sensor and a timer activates the solenoid allowing the entry of LN2 and afterwards it stops such supply of LN2 when the desired range of low temperature is reached. This type of cryostats include an inlet for refilling from the cryogen fluid deposit. Therefore it has likewise also an outlet for expelling gases when needed.
b) Through an electromechanical LN2 generator to fill a Dewar tank or cylinder. The LN2 generator unit dispenses on demand to the cylinder and this to the inner part of the cryostat. A small generator can dispense around 1. liter every 2.5 hrs., but it will stop LN2 generation when the internal storage is full until it is dispensed. This is better suited to medium volume users. The Auto-transfer system continuously produces LN2 and dispenses it automatically into an external 20 L or bigger storage Dewar. The average LN2 requirement rates of the open cycle cryostats of this patent range from the minimum of 1 liters per day of the smallest and best isolated cryostat to the 5 to 8 liters per day (depending on the materials, layout and other conditions) of the biggest unit of this patent to be used for cryopreserving large animals.
c) Directly from a LN2 generator. This is the less reliable alternative only to be used in an emergency case.

In all these three cases the said liquid nitrogen automatically leads through a hose and it is open or closed by an electromagnetic valve that allows the replenishment of liquid nitrogen to the cryostat only when electrically energized, otherwise it will not allow the entry of the cryogen liquid. Such LN2 production process takes place in four steps starting by air extract through a particulate filter and then compressed to a moderate pressure. Drying the compressed air is done in a series of purification steps to remove the carbon dioxide and other impurities, leaving only the portion of clean and dry nitrogen gas (78%) that undergoes the cooling process, resulting in LN2 to be transferred to a Dewar cylinder for intermediate storage or to a larger storage tank. The transfer of LN2 either to a small or larger thermal storage tank occurs through nitrogen pressurization condenser, forcing it through a transfer siphon to the appropriate container. The equipment works to provide a continuous supply of LN2 that uses what it needs and when necessary.

Furthermore, as an alternative to the above open cycle LN2 cryostat, an electromechanical closed-cycle cryo-cooler could be applicable using a mixture of cooling gases through a set of tubes located beside the back of the cryostat with the said certain similarities to the conventional refrigerators. That facilitates maintenance requirements and provides a stable low temperature solution, although these facilities are much more costly. These devices provide a high cooling capacity, while the workload is large. This type of cryostat could be more complex in bigger units due to various steps involved.

In general terms, the closed cycle cryo-cooler cryostats are mainly used only for very special purposes due to its expensiveness but it could result a yield-convenient device when power through a switch can be obtained in the low temperature vacuum chamber. In this case no cryogenic liquids are directly used, but a mixture of gases with modular designs for the workload; however, the cooling power is often limited, and may suffer vibration and noise due to the mechanical parts involved in its construction. The closed cycle cryo-cooler cryostats of this patent mainly consist of two stages in cascade refrigerating cycle. This is a process with said certain similarities to that used in common refrigerators. A fluid at an initial temperature is compressed while the compression heat is removed through air-cooled heat exchanger. The fluid is expanded to produce cold below the initial temperature using very efficient heat exchangers. The cryogenic system of this type require an air or water cooled and oil lubricated compressor.

The cooler unit is mechanically connected to the cryostat which has three stages. The first stage is the recipient with a “vacuum case” made of aluminum, duralumin, stainless steel and/or special plastics. The second stage is the intermediate or “radiation shield” and is responsible for reducing the radiation burden to the third stage known as the cold stage. The intermediate stage is only a cover for this latter.

Furthermore the third alternative of this patent are the said hybrid type cryostats which combine the advantages of electric cooling with the reliability of the flowing LN2, by including the above mentioned facilities to capture and recover the expelled boil-off N2 gas as it escapes from the cryostat. There is no interruption of cooling while the LN2 lost during power outages may be replenished at any time, although all these facilities—and the additional equipment involved—increase the cost of the capsule set.

The present invention relates to the said new portable insulation capsule units for long-term cryopreservation of biological materials for different purposes and sizes that can be used in any country (provided the relevant local legislation permits it) with the required conditions for long term cryopreservation of different biological materials.

These devices are ranging in size from the small capsule units including the cryo-preserving appliances to be used in any suitable location for umbilical cord blood, cord tissue, oocytes, stem cells or sperm mainly used for cryopreservation by said vitrification (a well known process of quick freezing, in which the liquid phase of a cell or group of cells is exchanged by cryo-protectants) and the long term storage of these cells, to the larger capsules of this patent capable to hold whole bodies of animals, which can be stored safely in these devices in cryo-suspension.

In the case of some plants or animals (e.g: pets or animals in danger of extinction), and in the case of deceased human bodies they can be cryopreserved individually intact wherever is legally permitted in the diverse countries. Human-size capsule devices of this invention could be stored even outdoors if so desired in most standard graves or some niches of average cemeteries with only small adaptations.

Other advantages of the invention will result from the following description given as illustrations but not limitative of these cryostat devices of this patent consisting of the following units:

Ion-Dewar capsule cryostat with cryo-protected cockpit for cryopreserving biological elements comprising: Source of could: External unit(s) for supply of cryogen consisting of liquid nitrogen (LN2) in the case of the open cycle cryostat alternatives with two LN2 interconnected refillable Dewar bottles or cylinders to supply the cooling system of the capsule based on an evaporator cryostat, or using one cylinder and a LN2 generator, all them interconnected by a 3 way electro-valve. Alternatively it will include a Condenser/Evaporator circuit in the hybrid and/or closed cycle alternatives.

A leak-proof inner vessel and specimen holders suspended within the cryostat, anchored to the top and covered by the cap in the case of smallest capsule (containing vials of 1.0 ml, 1.5 ml, and/or 3.5 ml for storing cells, blood/serum specimens, sperm, and other biological fluids at vapor-phase LN2 temperature −196° C.) or to the bottom in the case of the rest of the capsules, in a base to anchor various system elements.

A computerized Control unit, controlling directly the thermal sensors and other sensors, while connected on line with any (customer or central unit) smartphone, tablet or table computer via internet as described below by using said particular App included for monitoring and controlling the whole system operation. This computer and its communication system includes a processor for the local system, access control, remote unit, audible alarm and wireless communications. Cryo-temperature sensors/thermometer. Electro-mechanical valves. Helical fan anchored in the ceiling in the case of bigger open-cycle cryostats.

External protective radiation shielding enclosure, mainly made of metallic aluminum foil or equivalent radiation shielding materials. Ancillary units: Include batteries arid battery charger (to be automatically activated when interruptions in the power supply arise) power supply and a series of optional sources of such power supply including alternatively a small windmill generator and/or solar panels, with all motors, interconnections, etc. (like in the case of a Tesla Powerwall battery system and related power supply devices).

Storage conditions would be monitored to control the security of the elements involved as mentioned below, and as alternatives for this security it may include an emergency diesel generator engine, a UPS (uninterruptible power supply) system, an additional endorsement of liquid nitrogen supply, a secure location accessed with a key card, and a video surveillance facility. Description of the container and its casing:

This product consists of a capsule made of materials which are not affected from any low temperature brittleness like duralumin, aluminum or said special plastics like polyurethane or other said equivalent materials, stainless steel or alloys, especially the Nickel based alloys with excellent cryo-resistant properties.

The container and its casing form two concentric units, with reinforcement sheets to increase its structural rigidity.

The external part of the capsule is covered with radiation shielding, while the upper surface of the casing is provided with a flange and a cover secured by screws and/or an electromechanical lock.

The thermally insulated space between the container and the casing is gotten by one of these two alternatives:
a). Vacuum (as in any Dewar), while a vacuum pump is used during construction, as the insulating element between the container and the casing, by using for its construction (or repairing) two solenoid valves, allowing the execution of the vacuum in the space between the container and the external casing.
b). Granulated Perlite to be used instead of vacuum in the required volume as the main insulating element between these concentric capsules.

The container has a double layer as described above, between which vacuum or Perlite has been located to prevent/minimize the flow of heat by conduction and/or convection. The outermost surface is covered with fiberglass painted with very reflective substances to avoid/minimize transmission of heat by radiation. It will also include two door hinges and a snap closure with rubber gaskets.

### Technical Specifications of the External Cover:

To be built with polyurethane or duralumin, said special plastics or stainless steel sheets AISI 304. In this later case the design load of the bigger capsule is 180 kg, and the dimensions for the human-size biologic materials cryopreservation unit of the basic A model (see figures)are:

Width: 600 mm.

Height: 400 mm.

Length: 2000 mm.

There is a protective enclosure for the whole local system and 12 main metal or rigid polyurethane parts as spacers between the two sheets and their position will allow the continued gap between the spaces separating the inner vessel and outer container. The dimensions of the basic model are 300 mm.×800 mm. and these parts will serve to provide structural rigidity to the capsule. The door is constructed with double layer with a filling of high density polyurethane of 40-45 kg./m3.

Weld: In the case of steel, the welder used for the construction of the capsules is continuous welding. Metal arc welding protected. 308-15 electrode according to AWS 5.4-81.

For the construction of the rigid polyurethane capsules of this patent, 3D printing machines with 3D printing software are used for obtaining the plastic molds, using a milling machine and then by injecting this polyurethane in the previous plastic mold obtaining so the rigid polyurethane capsule housings including all the parts that will provide structural rigidity to the capsule into which the granular perlite and other thermos-insulation materials including expanded polyurethane—is dropped, inserted, compacted and disposed. The door is constructed with a double layer with a filling of high density polyurethane of 40-45 kg./m3 and/or other suitable materials.

Measure dimensions of the thermoplastic polyurethane capsules of this patent are described in the figures below.

Valves: Filling electro-valves of Nitrogen LN2 are normally closed type Magnatrol “A” ½ “bronze 18A52. If Vacuum is used: two (2) valves will be required during construction/repairing, normally closed and NPSF 0106677 P1 12-3 of ⅛” inch.

This design generates sufficiently output “loose” so that in the case of open cycle units the said. Nitrogen gas can evaporate without generating pressure buildup therein. The various components will use High Vacuum Grease which is free of silica and halogens. The design of this includes cryogenic instrumentation for temperature control including at least one special cryo-temperature thermometer.

The set is equipped with power and control systems (comprising also the items located outside of the cryostat, like the external cryogen source) both equipped with hand gear, and in the case of the open cycle with a pressure gauge, of which the first indicates the pressure inside the container and the second the pressure when leaving said LN2 feed duct consisting of two fully automated circuit connecting the cylinder and the NL2 generator or the two cylinders with the cryostat through the said electromechanical three-way valve.

Dimensions/Sizes of capsules: As a general rule, the smaller sized units of this invention could use heavier materials such as stainless steel because weight may be not as important as it is for the bigger units to be used also for shipping besides the long time storage.

Cryo-protected internal chamber: The leak-proof vessel inside the case where the biological materials will be deposited for cryopreserving. The biological materials are deposited in such carrier vessel intended for the same, conveniently isolated in a sample holder—for cell samples vials—able to hold the special straw protectors or sealed plastic bags made of cryo-resistant materials for larger samples that can be exposed to the temperature indicated by the cryopreservation professional/user. This temperature will be set to lower down in a particular cadence as required by the specific biological materials case needed and will be finally stabilized around −195° C. permanently and indefinitely until it is eventually decided to revert the process for the recovery of such biological materials.

If the equipment is to be used in an out of lab location, a weatherproof cabinet housing system will be included. In the case of the small open cycle unit this will be a small cabinet with wheels holding the small cryostat of around 1 m. long with a front door, the NL2 cylinders and a ceiling fan while the base of the cabinet will be perforated along its entire surface to facilitate the free circulation of air inside the compartment.

In the case of closed cycle cryostats of this patent, the ones using the Klimenko (Kieemenko) cycle that was developed and widely used by the Liquefied Natural Gas industry (LNG) are the lower cost and more lightweight ones of this kind. They use a one-flow in-cascade cycle that works with a mixture of liquid and compressed gas that pass down a countercurrent exchanger, allowed to expand through a throttling (or capillary) valve with low power consumption and very few maintenance requirements. It is a single stream mixed cryo-cooling system used to liquefy gases where cooling occurs upon expansion, and the cool gas passes back up the heat exchanger, precooling the incoming high-pressure gas.

External supply of liquid N2. It normally consists of corrugated aluminum cylinders LN2 Dewars available in the market (in several standard sizes with the output mechanism above mentioned with the inlet electro-valve housing, designed for storing and dispensing small amounts of liquid nitrogen, in order to maintain the proper indoor temperature. These cylinders are easy to operate while the system pressure cap and the above described valves ensure easy access without unnecessary exposure to cryogenic LN2. For the filling of the LN2 supply tank, this can be connected by a small inlet valves,

LN2 generators results in a much greater autonomy with no external supply dependence requirements. This consists of automated small portable units generating LN2 production and connected to an intermediate cylinder tank or (in the case of any failure in this cylinder) directly to the Ion Dewar capsule. The flow of liquid Nitrogen supplied to the Ion-Dewar cryostat container will depend on the mass of product evaporated and the temperatures at the inlet and outlet thereof, which aims to keep it in the vicinity of −196° C. inside the container at atmospheric pressure.

Ancillary and Optional Facilities of this Invention
1. The internal temperature sensor probes system that detect the variations of temperature in the chamber of the capsule include an external viewfinder for manual or automated adjustment and alternatively two or more temperature sensors that detect the temperature in two or more different site levels of the the inner vessel to maintain the pre-determined target temperature inside the chamber. Optionally it includes a dipstick for additionally determining and maintaining the correct level of liquid Nitrogen into the container.
2. The LN2 generator must be plugged to the power supply when it is needed to be activated or alternatively, in cases of difficulty of getting external power supply in a given area, it could work with batteries for a time specially if it includes wind power (mini wind-mill unit) and/or PV solar panels using such one or more batteries and various regulators, or even a combination of both (hybrid drives)
3. As a further embodiment, in the case of cryostats for humans there could be included, attached to the external part of the container a small isolated box of 15×15×2 cm., with enough capacity to contain and store a small hard drive or a pen drive containing digital and/or physical information including all patient medical information and medical history including any x-ray and scanning pics, clinical analyses, etc. and all matters relating to the intervention of cryopreservation itself and the elements used in the same, and may also include personal files and personal history information of the patient digitized texts, photos, films, sounds etc. that the person wanted to have beside to be preserved with the keys given to the last will designed executor. Another small box lined with insulation sealed can store objects of sentimental value (all them without any economic value) the patient wants to have next and which are sealed and low temperatures resistant.
4. As another option a side opening of the container door with hinges is made in the cryostats of this patent to facilitate a part of the surgical intervention (in the case of MD's or veterinary practice) in the same container if necessary, under required cooling in field conditions.
5. The option of an internal and external transparent window of borosilicate glass if desired for exposure of the face (inside the helmet) or the entire body of the person or the animal inside these cryostats has been included. At sub-zero temperatures, the tensile strength of borosilicate glass tends to increase and so these transparent pieces of glass equipment can be used with safety at cryogenic temperatures. If two plates borosilicate sandwich glass is used it must have no air inside. As an alternative other thermos-resistant transparent or translucent plastic materials can be used.
6. These containers will have a numbered recording inside and out with the patient's name for easy identification and the carcasses may be customized on the outside with paintings of symbols, flags, etc. to suit the patient wishes.
7. For the easy transport of the capsule container it has been included an optional non-integrated mobile stretcher with castors of various sizes depending on the function, and enhanced (both the structure and the wheels) to comfortably support the weight of the container.
8. As another option of this patent, the cold source may be collectively used and in this case it may consist of a large container with several “cold fingers” on the Ion Dewar containers. Up to 20 capsules of this type can be more securely positioned within a single cold source both in the case of a hybrid cryostat alternative of this invention or with a LN2 generator or in the case of open cycle one, with a module with windows to store together entire families (where legally allowed) in their suits for a long period of time. In this case, the container can be immersed in LN2 in whole or in a part, or rather in the vapor space above the LN2. The only requirement is that the environment surrounding the container gets a temperature distribution such that the net flow of containers is positive or zero when the thermal conductivity of the container reaches the desired temperature.

Advantages of the Invention. The present invention has the advantage of being a storage cryopreservation container which can be placed in almost any normal environment or field condition where the ambient temperature exceeds the desired temperature for cryo-preservation. If storage containers should be transported over long distances, it can be moved easily within the same capsule. The designs of this invention also minimize energy requirements.

Another advantage of the capsules of the present invention is to provide an autonomous cryopreservation storage system of biological samples or materials that can be completely leak-proof, sealed for delivery (airfreight or any other fast cargo. i.e: using dry ice hermetically for cooling during transport) to any country, provided local law authorizes it. The monitoring of the temperature is electronic, without any moving parts to wear out. Power requirements are modest, and are very low if the environment is cold enough to minimize the net flow of temperature inside the container. Several standardized characteristics of the designs of this invention were also conducted to satisfy the needs of long duration and lightweight construction for easy transport.

If additional insulation is required for the apparatus of this patent some materials can be added to the external side using combinations of the different suitable materials like polyurethane, air-gel, perlite, vermiculite, glass fiber, cellulose fiber, polyester fiber, polyethylene, polyurethane, etc. The most efficient thermal insulation is vacuum, followed by perlite.

In the case of open cycle cryostats, the capsules should preferably be placed horizontally for a better distribution of temperatures inside the container. The bottom of the cryostat should be there at a temperature of about −196° C.

Steam temperature in the Ion-Dewar open cycle cryostats of the patent is stratified such that the upper part of the vessel can reach a temperature of −133° C. while the average target temperature of the chamber can average —150° C. If the lower half of this surface is at −196° C. and the inner chamber temperature is of −150° C., LN2 consumption will be about 5 liters per day in the case of an average human size open cycle cryostat horizontally placed in this fashion.

As said above, there are several configurations to choose from within this invention. The more common, as this design allows the largest section to accommodate a greater volume of liquid. These and other advantages of the invention set forth in this description are given for illustrative but no-limiting purposes.

Cryogenic storage system. The present invention provides devices and methods arranged to work in decreasing temperatures and thereafter during long-term storage of biological materials at cryogenic temperatures. Storage devices of the invention are adapted for placement in a cold source to maintain the device and materials stored in it at a uniform cryogenic temperature for an extended period of years without structural failure, leakage or contamination of the materials in the inner chamber of the container.

The devices of the invention are designed for biological use by or under supervision of scientific, medical or veterinary professionals for both cooling, transport and long term storage of biological material at the desired cryogenic temperatures.

The invention provides the “passenger compartment” in the container of the patent for the biological material for cryopreservation in the long term, while the various medical or veterinary treatments are not part of this patent and are regulated by the laws of each country.

Controlling equipment & Software. The cryo-preserving devices of this patent include a microcomputer based monitoring system with the ad hoc software that will detect, compute, report and/or directly correct certain functions/variables when they are out of the normal or expected range.

This will also include, but not be limited to check and monitor the temperature sensors, the LN2 levels and its pressure, the power supply (for both the main unit and the hardware including the monitor itself), open or closed state devices, container properly situated, etc.

Normal and abnormal conditions will be reported to the unit visually and/or aurally and that will also be transmitted to various receivers via wireless and wired signals such as, but not limited to, WiFi, ethernet protocols, Blue Tooth, USB, etc.

The Wi-Fi connection will allow spread the monitored information through Internet and to be received by an App developed for, but not limited to, Apple, Android, Windows or Linux. This application will alert the user if any of the normal conditions have changed in order to make the proper adjustments in the cryogenic device.

The App of this patent will not be limited to monitor the information of the cryostat but it will also be able to share data with other App users and servers to share the information received by the different systems.

One embodiment of the control device includes an adjusting apparatus for supplying LN2 to the container and at least one temperature sensor which detects the temperature in the chamber of the container and as a further embodiment two or more temperature sensors which detect the temperature in two or more different sites on or within the container to maintain a given temperature in the chamber. Control can be via passive control (user setting), or through active control on/off control (automatic when it falls below or above a predetermined temperature), according to the algorithm suitable for the purpose of controlling the work cycle to maintain the desired temperature in the chamber. It can be adjusted by adding or reducing the cryogen LN2 automated supply to the zones of the device to maintain the most possible uniform temperatures inside the chamber.

These capsules will have a specific computer control during the specific cooling process of each particular sample of biological materials, and especially in the case of human cells, tissues, organs or bodies of the patients to ensure that the cooling rates in time are the adequate for each biological material characteristics both when the rapid cooling is above the Tg (glass transition temperature) and when it is slow below Tg (to reduce the fracture due to thermal stress).

The controlling system of this invention include three alternative types of controllers, depending on the simplicity of the cryostat and the system to be controlled: on-off, proportional and PID (proportional, integral and derivative values). Three-term control to be individually adjusted or “tuned” to a particular system using trial and error practice.

These values can be interpreted in terms of time: P depends on the present error, I on the accumulation of past errors, and D is a prediction of future errors. The weighted sum of these three actions is used to adjust the process via some control element such as the activity of the LN2 entrance at the electro-valves, or the power supplied to the cryostat, which helps the unit to automatically compensate for changes in the system. These adjustments are expressed in time-based units, so once “tuned” the parameters in the PID algorithm, the controller can provide control action designed for specific process requirements.

The computer receives the data from the sensors and results so programmed to activate the electro-valves to change the circuits as marked by the minimum temperature at which the opening of the electromechanical valve would be triggered, allowing the entry of LN2 The thermometer should also report the temperature at which the electromechanical LN2 induction valve would close, and also requests for a number of further actions like the replacement of one of the empty cylinders which is sent in real time. Optionally it can be programmed to receive signals from a sensor of water penetration and sensors of fire.

Comments on the ways of using this invention. The following comments on the ways of using this invention are merely an aid to understanding its features and not for describing or representing the technique of the invention itself. It is noted for information purposes and not limited to the following:

Once cooled safely below the glass transition temperature, there is no known time limit beyond of which the safe storage facilities of biological materials (the objectives to cryopreserve of this invention) cannot continue. A recent study of umbilical cord stem cells at the University of Indiana has demonstrated its viability after 23.5 years of cryogenic storage. In addition, the bone marrow has been stored for decades and has remained viable.

In the case of animals, veterinarians apply different treatments depending on the case and type of animal. The Cryonics Intitute (CI) U.S. uses a mix for the vitrification of animals (mammals) called CI-VM.

In the case of Cryopreservation of umbilical cord blood and cord tissue, the specializing firms (like Cryo-Cell and others)normally process these cord blood cells using hydroxyethyl starch (beta-starch) to reduce the number of red blood cells while concentrating the nucleated white blood cell fraction, containing the stem cells. These cells are mixed with the cryo-protectant DMSO and dextran or KitaZato (the widely used commercial cryoprotectat product manufactured by Biopharma Co. Japan), and the resultant solution is introduced in cryo-straws that are sealed and hold cell samples of 20 ml., along with cord segments for testing, and stored in special cryo-compartmentalized cylinder-shape vial sample holders or cryo-bags. They doubly wrap and house them in a protective cassette when placed in the vapor phase liquid nitrogen for cryopreservation.

The U.S. firm Alcor currently uses a cryo-protectant solution agent (CPA) called M22, developed by researchers at the major tissue banks, making obsolete the previous B2C, with better preservation of the biochemical and functional capacity.

This solution must also contain a non-penetrating solutes suitable carrier solution, as LM5 in isotonic concentration brought to pH 8. The M22 supports up to a critical cooling rate of about 0.1° C. per minute, and a heating rate of 0.4° C. per minute after rapid cooling. Critical heating rate is about 1° C. per minute after slow cooling. This is more than sufficient for vitrification of a structural tissue of human brain size. Incorporation of synthetic nanopores can significantly reduce toxicity and cell injury due to osmotic shrinkage caused by CPAs during the cooling and process by reducing CPA exposure time and enabling rapid CPA loading and unloading at lower temperatures.

In the case of human bodies, the current law of many countries requires a few minutes of cardiac arrest before the medical pronouncement of death and the subsequent starting of any medical procedures of cryopreservation in human terminal patients (while in the veterinary practice this is not needed and in some tests with dogs and they have recovered excellent brain function after 16-60 min. complete cerebral ischemia).

The cryopreservation process in humans begins immediately after clinical death has been pronounced and legally filed. Then the individual organs including the brain remain biologically alive, and cryo-preservation procedures including vitrification (especially the brain) is feasible. This principle is what allows transplant organs (like heart or liver) although they come from deceased donors. Human brain can be cryo-preserved and delivered in the small cryostat of this patent.

Physicians (or veterinarians in the case of animals) try to minimize the damage due to ischemia with perfusion (a long and gradual fluid CPA intravenous injection. The catheter is inserted into a vein) starting with cardio-pulmonary support (much like the CPR) and simultaneously cooling the body as soon as possible after the declaration of clinical death (or authorized euthanasia in the countries where this is legal), and immediate supply of anti-coagulants such as heparin, antioxidants and other products designed to protect the cell structure before lowering the temperature further. Once the body is at −3° C. the brain can be temporarily deprived of oxygen. Blood is then normally removed from the circulatory system and replaced by a heparin (anti-coagulant) and an antifreeze solution with glycerol and/or other CPA cryo-protectants. To this end, doctors must reverse the circuit introducing these agents, because if not the heart valves prevent the entry of liquid into the lung cavity. This operation in the case of humans takes 4 to 6 hours.

This blood taken from the circulatory system could be donated to a blood bank according to the patient wishes if feasible and/or a sample stored in an adequate plastic bottle with cryo-protectant liquids and placed inside the same cryostat or somewhere else in other cryostat to remain cryo-preserved in a cryopreserving institution.

Once this operation is completed according to the medical protocols, in the case of humans the patient is dressed with a custom-designed hermetic “special suit” of this patent (tailor made) very well insulated with a leak-proof helmet and surrounded initially by ice and silicon (which is non-toxic and remains liquid at very low temperatures), or dry ice and can be placed in the Ion—

Dewar capsule of this invention. Alternatively the body can be placed in a so-called “cryo-sleeping bag” consisting of a hermetic special plastic bag. The capsule must be adjacent to the operating room and can be moved while the cooling increases gradually with computerized temperature control until reaching −°79 C.

The patient (with the cryo-dress of this invention) may be moved in the same Ion-Dewar capsule container with dry ice or partially full of liquid nitrogen (in the case of the open-cycle continuous flow cryostat) to the place where it will remain until further thawing sine die.

The LN2 is maintained at its boiling temperature of −196° C. which upon evaporation produces a constant cooling of the inner vessel of the Ion Dewar container. For maintenance, it only requires to provide regularly LN2 automatically, semi-automatically or manually (in the case of the most simple open cycle units) from the adjacent Dewar LN2 cylinder.

References to Tables. There are included herein 4 Excel tables which are also presented in the 4 table JPEG image format to facilitate the presentation. These are only the basic models, where metal materials are substituted by cryo-thermoplastics and/or other materials in the alternative models of this patent with different geometry as described in the text arid figures

Table 1 refers to the model A capsule (standard human size) materials and weights in the basic open cycle cryostat version.

Table 2 refers to the model B capsule (standard animal size) materials and weights in its basic open cycle cryostat version.

Table 3 refers to the model c capsule (organ size, including human brain) materials and weights in its basic open cycle cryostat version.

Table 4 refers to the model D capsule (umbilical cord & other cells samples) materials and weights in its basic open cycle cryostat version.

TABLES of basic models, where metal materials are substituted by cryo-thermoplastics and/or other materials in the alternative models of this patent with different geometry as described in the text and figures.

TABLE 1
MODEL A -Ion Dewar Capsule
(standard human size)
CRYOGENIC GIB 2014

| | MODEL A- 185/70/50 | | | | | Weights |
|---|---|---|---|---|---|---|
| Item | Designation | Material | Measures(mm) | Quant | Density | (Kgs) |
| 1 | Outer Box | Aluminum | 1800 × 650 × 335 | 1 | 2.7 | 22.77 |
| 2 | Inside Box | Aluminum | 1744 × 544 × 282 | 1 | 2.7 | 19.07 |
| 3 | Ring of | Flexible | 5356/65 × 86 | 1 | 0.3 | 8.9 |
| | Pressure | polyurethane | | | | |
| 4 | Separators Base | Thermoplastic | 300 × 70 × 50 | 5 | 0.8 | 4.2 |
| | | polyurethane | | | | |
| 5 | Lateral | Thermoplastic | 150 × 70 × 50 | 8 | 0.8 | 3.36 |
| | Separators | polyurethane | | | | |
| 6 | Separators in | Thermoplastic | 150 × 70 × 50 | 4 | 0.8 | 2.1 |
| | foot and head | polyurethane | | | | |
| 7 | Digital | | | 1 | | 0.3 |
| | Thermometer | | | | | |
| 8 | Fill Solenoid | Stainless Steel | 222LT Series 262 | 1 | | 0.32 |
| | LN2 | | | | | |
| 9 | Frame with | Thermoplastic | 1850 × 700 × 500 | 1 | 0.4 | 51.4 |
| | door | polyurethane | | | | |
| 10 | Insulation | Expanded | | | 0.15 | 16.68 |
| | between boxes | Perlitas | | | | |

| | |
|---|---|
| Total Weight | 129 |

TABLE 2
MODEL B -Ion Dewar Capsule
(standard animal size)
CRYOGENIC GIB 2014

| | MODEL B- 95/45/40 | | | | | Weights |
|---|---|---|---|---|---|---|
| Item | Designation | Material | Measures(mm) | Quant | Density | (Kgs) |
| 1 | Outer Box | Aluminum | 900 × 400 × 235 | 1 | 2.7 | 7.34 |
| 2 | Inside Box | Aluminum | 794 × 294 × 182 | 1 | 2.7 | 4.62 |
| 3 | Ring of | Flexible | 2520/65 × 86 | 1 | 0.3 | 8.45 |
| | Pressure | polyurethane | | | | |
| 4 | Separators Base | Thermoplastic | 300 × 70 × 50 | 4 | 0.8 | 3.36 |
| | | polyurethane | | | | |
| 5 | Lateral | Thermoplastic | 150 × 70 × 50 | 6 | 0.8 | 2.52 |
| | Separators | polyurethane | | | | |
| 6 | Separators in | Thermoplastic | 150 × 70 × 50 | 4 | 0.8 | 1.68 |
| | foot and head | polyurethane | | | | |
| 7 | Digital | | | 1 | | 0.3 |
| | Thermometer | | | | | |
| 8 | Fill Solenoid | Stainless Steel | 222LT Series 262 | 1 | | 0.32 |
| | LN2 | | | | | |
| 9 | Frame with | Thermoplastic | 950 × 450 × 400 | 1 | 0.4 | 23.22 |
| | door | polyurethane | | | | |
| 10 | Insulation | Expanded | | | 0.15 | 14.4 |
| | between boxes | perlitas | | | | |

| | |
|---|---|
| Total Weight | 66.11 |

TABLE 3
MODEL C -Ion Dewar Capsule
(standard organ size)
CRYOGENIC GIB 2014

| | MODEL C GIB 65/35/35 | | | | | Weights |
|---|---|---|---|---|---|---|
| Item | Designation | Material | Measures(mm) | Quant | Density | (Kgs) |
| 1 | Outer Box | Aluminum | 600 × 300 × 185 | 1 | 2.7 | 4.16 |
| 2 | Inside Box | Aluminum | 494 × 194 × 132 | 1 | 2.7 | 2.24 |
| 3 | Ring of | Flexible | 1642 × 65 × 86 | 1 | 0.3 | 2.75 |
| | Pressure | polyurethane | | | | |
| 4 | Separators Base | Thermoplastic | 300 × 70 × 50 | 4 | 0.8 | 3.36 |
| | | polyurethane | | | | |
| 5 | Lateral | Thermoplastic | 150 × 70 × 50 | 6 | 0.8 | 2.52 |
| | Separators | polyurethane | | | | |
| 6 | Separators in | Thermoplastic | 150 × 70 × 50 | 4 | 0.8 | 1.68 |
| | foot and head | polyurethane | | | | |
| 7 | Digital | | | 1 | | 0.3 |
| | Thermometer | | | | | |
| 8 | Fill Solenoid | Stainless Steel | 222LT Series 262 | 1 | | 0.32 |
| | LN2 | | | | | |
| 9 | Frame with | Thermoplastic | 650 × 350 × 350 | 1 | 0.4 | 13.5 |
| | door | polyurethane | | | | |
| 10 | Insulation | Expanded | | | 0.15 | 8.3 |
| | between boxes | perlitas | | | | |

| | |
|---|---|
| Total Weight | 39.5 |

TABLE 4
MODEL D -Ion Dewar Capsule
(standard umbilical cord blood & tissue size) - Multiple Samples
CRYOGENIC GIB 00 2014

| | MODEL D GIB 30/20/17.5 | | | | | Weights |
|---|---|---|---|---|---|---|
| Item | Designation | Material | Measures(mm) | Quant | Density | (Kgs) |
| 1 | Outer Box | Stainless Steel | 250 × 150 × 90 | 1 | 7.8 | 0.854 |
| 2 | Inside Box | Stainless Steel | 150 × 50 × 39 | 1 | 2.7 | 0.32 |
| 3 | Ring of | Flexible | 272 × 25 × 62 | 1 | 0.3 | 0.41 |
| | Pressure | polyurethane | | | | |
| 4 | Separators Base | Thermoplastic | 20 × 30 × 50 | 2 | 0.8 | 0.05 |
| | | polyurethane | | | | |
| 5 | Lateral | Thermoplastic | 20 × 30 × 50 | 2 | 0.8 | 0.05 |
| | Separators | polyurethane | | | | |
| 6 | Separators in | Thermoplastic | 20 × 30 × 50 | 1 | 0.8 | 0.05 |
| | foot and head | polyurethane | | | | |
| 7 | Digital | | | 1 | | 0.3 |
| | Thermometer | | | | | |
| 8 | Fill Solenoid | Stainless Steel | 222LT Series 262 | 1 | | 0.32 |
| | LN2 | | | | | |
| 9 | Frame with | Thermoplastic | 300 × 200 × 175 | 1 | 0.4 | 2.95 |
| | door | polyurethane | | | | |
| 10 | Insulation | Expanded | | | 0.15 | 0.83 |
| | between boxes | perlitas | | | | |

| | |
|---|---|
| Total Weight | 6.134 |

The invention claimed is:

1. A Portable, insulated capsule for cryopreservation of biological materials: A device (herein named Ion-Dewar), which can be used in biological, veterinary or medical practice for both the process of controlled cooling in field conditions and the long term cryopreservation of cells, tissues, organs, portions of organs or entire bodies, and also involves equipment and a method for long term storing of these biological materials under a cryogenic temperature, comprising a thermally insulated container made of steel, aluminum, duralumin, copper, thereto-stable of plastic materials or different alloys with at least one thermal insulation layer made of perlite or vacuum, an outer radiation shielding protection and a specific cold source like LN2 connected to the container that keeps such biological materials at a cryogenic temperature.

2. The cryopreservation capsule device according to claim 1, wherein the cryostat can be set in an hermetically closed mode for shipping the capsule while temporarily refrigerated inside the inner vessel which contains the specimen holder with leak-proof closing of the cap opening at their top, and it can later be opened when permanently connected to the cryogen source in the long term storage modality.

3. The cryopreservation capsule according to claim 1, where the device for cryogenically freezing, storing and transporting live biological materials in an inner vessel which contains the specimen holder is suspended in a cryo-protective liquid medium. This specimen chamber held within the inner vessel is accessed through the cryostat openings at their tops connected together by a neck portion forming a space between the outer casing and the inner vessel and an opening into the inner vessel.

4. The cryopreservation capsule according to claim 1, where the cryostat comprises: a cryopreservation vessel, a container which houses the cryopreservation vessel; and wherein the cryopreservation vessel comprises a vessel body which holds a low-temperature liquefied gas with a cap forming an evacuable space containing thermal insulating material to inhibit the transfer of heat therethrough, while the upper zone is equipped with a flange and a cover secured by screws, with a lower anchor in a base containing a battery and a battery charger and a computerized PID control software systems that govern the whole operation, being also provided with power supply and control systems and includes a key lock that facilitates the access to its interior

5. The Portable, insulated capsule for cryopreservation of biological materials, according to claim 1, in which the smallest size Ion Dewar cryostat of this invention could be considered an appliance for the conservation of biological materials, being specially designed for cryopreservation of umbilical cord blood, stem cells as well as other small tissues or cells. Features of this small capsule include a cryostat, consisting of a stainless steel, duralumin, polyurethane or said alternative materials and one of the embodiments includes a small closet with rolling wheels for housing the whole set when a non-laboratory location is desired. This small capsule may content a significant quantity of umbilical cord blood and/or umbilical tissue (or any other cell or tissue) samples from several persons of a family or any groups of persons if so desired using only one single capsule.

6. The method of claim where in the case of humans once the body is ready to enter at the cryopreservation vessel, he or she is dressed with a custom-designed hermetic special dress suit of this invention made of special fibers and materials including cryo-resistant garment of polymer materials (such as Polypropylene with high translucence and/or Polycarbonate) in standard sizes and/or tailor made, and using both thereto-amenable fabrics and welding-gluing and/or plates resistant to cryogenic temperatures or with cryo-treatments in its manufacturing, all them very well insulated with a helmet comprising a leak-proof fit to be hermetically adjusted to the rest of the dress suit. This dress of the invention can be purchased apart and also can be used for other purposes different of cryopreservation if so desired, and/or in another fashion.

7. A portable, insulated cryopreservation shipping and long term storage capsule as recited in claim 1, wherein the rigid part of the capsule is made of thermoplastic materials including rigid polyurethane. The outer housing, the inner vessel and the specimen chamber have a chamber wall comprised of both rigid outside (and foam inside with perlite and aluminum) thermoplastic material like said polyurethane that is cryogenically compatible with an outer shipping container shell and a support assembly providing lightweight along with impact and vibration resistance to the vessel and the whole cryostat capsule of this patent.

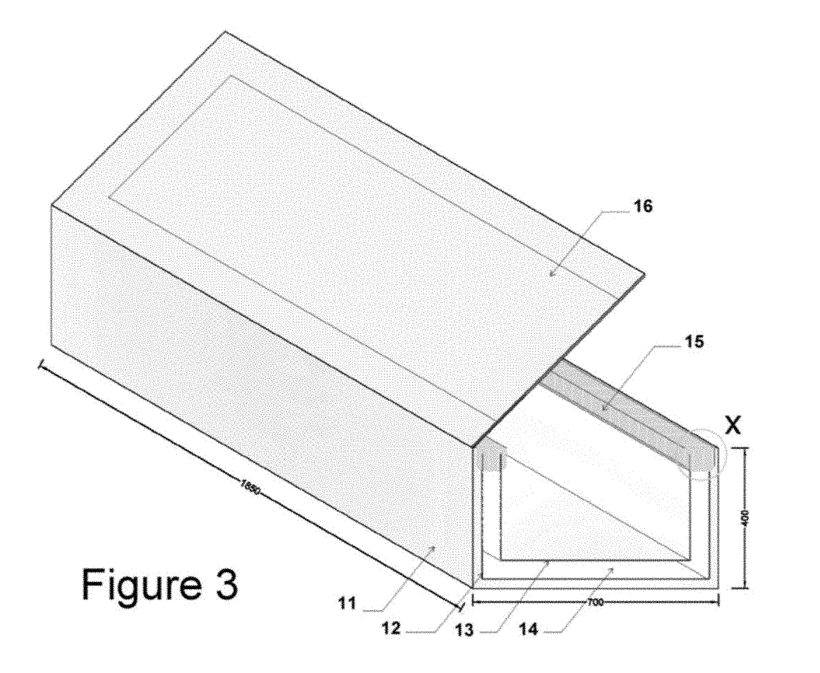

8. The cryopreservation capsule according to claim 1 wherein the cryopreservation unit is an alternative hybrid cryostat (as shown in FIG. 3A.) comprising all the elements required for an automated long term cryopreservation in this type of cryostat with alternative sources of cryogen and sources of energy capable to work even under a number of very adverse situations. Alternatively, when the said capsule is a closed cycle unit it comprises: i) a gas-tight chamber having a bottom and an open top; ii) a heat-exchange plate in the bottom of the gas-tight chamber; iii) a gas inlet for admitting a cryogen into the gas-tight chamber.

9. The cryogenic apparatus of claim 1 characterized by the fact that the capsule further comprises four (or at least one) temperature sensors which detects the temperature in the chamber or the device where two or more temperature sensors detect the temperature in two or more different sites or containers as appropriate.

10. The cryogenic capsule apparatus of claim 1 further characterized by a top housing secured over the top of the capsule opening, said top housing comprising an annular portion forming a central opening in communication with the cryostat opening to allow the insertion and withdrawal of one or more specimen holders.

11. The method of claim where the cold source is a cylinder cryogenic Dewar, connected to the cryostat capsule and a generator of LN2, by using a 3 way electro-valve interconnecting the above 3 elements.

12. The method of claim where the biological materials to be cryo-preserved consist of biological cells, tissues, organs and/or whole bodies of plants, animals or humans where this practice is legal. The apparatus is suitable for the cryopreservation of all types of biological cells, with most systems including the ultra-fast cooling/warming system to be used to achieve vitrification of individual cells or cell suspension with a low concentration of cryo-protectant agents to attenuate the formation of intra-cellular ice crystal formation during cooling, and to minimize de-vitrification during subsequent warming.

13. The Ion-Dewar cryogenic device of claim 1 characterized by an independent unit, portable autonomous apparatus, with minimum maintenance requirements for cryopreservation including previous in situ placing and pre-cooling in field conditions of such biological materials, including whole bodies of animals and in the case of human bodies they may be preserved intact individually and safely shipped within these devices in any country in the world for further long-term cryopreservation storage.

14. The Ion-Dewar cryogenic apparatus of claim 1 wherein several devices and methods are provided for cryogenic storage of biological material for long term and consists of the following units: a) Ion-Dewar container with thermal insulation layer, b) Cockpit cryo-protectant inside vessel to preserve biological materials, previously treated with cryo-protectants and anti-freeze agents for a convenient vitrification of such biological materials contained in cryo-bags or in special dresses for persons or even animals when desired, inside the sample holder.
c) External unit control and supply of liquid nitrogen (LN2) for open cycle cryostat alternatives, d) Ancillary units and components including connections to the power source, a fan in the top and a thermostat which drives the fan when it is required to reduce the external temperature when it is too high.

15. The cryopreservation capsule according to claim 1, wherein the cryopreservation cryostat can be attached and connected by a small inlet valves to a pair of refillable LN2 cylinders or directly to a LN2 generator, which results in greater autonomy of supply with minimum maintenance requirements.

16. The cryopreservation capsule according to claim 1, wherein the controlling device includes an adjusting apparatus for supplying LN2 to the container and one or more temperature sensors which measure this accurately in one or more different sites within the container.

17. The cryopreservation capsule according to claim 1, wherein the devices of the invention can be used by a medical or veterinary professional to provide pre-cooling to the body temperature at the specified cadence for both transport and storage of these bodies or any other biological materials for further long-term cryogenic suspension.

18. The cryopreservation capsule according to claim 1, wherein the apparatus is suitable for most commonly used methods for the successful cryopreservation of biological materials including whole organs, organ sections, tissues and cells, in a non-frozen (vitreous) state, comprising the pre-cooling and controlled cooling of such biological materials to be preserved in the presence of a non-toxic vitrifiable protective solution (CPA) to at least the glass transition temperature thereof to vitrify the solution without substantial nucleation or ice crystal growth and without significant injury to the biomaterials. In the case of closed cycle cryostats of this patent, the lowest maintenance requirements and lowest power consumption alternative to be used is the one-flow in-cascade Klimenko cycle single stream mixed cryo-cooling system that works with a mixture of liquid and compressed gas that pass down a countercurrent exchanger allowed to expand through a throttling (or capillary) valve where cooling occurs upon expansion, and the cool gas passes back up the heat exchanger, precooling the incoming high-pressure gas.
